(19) United States
(12) Patent Application Publication
(10) Pub. No.: US 2025/0208320 A1
(43) Pub. Date: Jun. 26, 2025

(54) HIGH-RESOLUTION POLARIZATION-SENSITIVE IMAGING AND POLARIMETRY APPARATUS AND METHOD THEREOF

(71) Applicant: 10644137 CANADA INC., Heritage Pointe (CA)

(72) Inventors: Hamid Pahlevaninezhad, Lexington, MA (US); Majid Pahlevaninezhad, Kingston (CA); Sam Scherwitz, Calgary (CA)

(73) Assignee: 10644137 CANADA INC., Heritage Pointe, AB (CA)

(21) Appl. No.: 18/847,620

(22) PCT Filed: Mar. 16, 2023
(86) PCT No.: PCT/CA2023/050343

§ 371 Date: Sep. 16, 2024

Related U.S. Application Data
(60) Provisional application No. 63/320,589, filed on Mar. 16, 2022.

(51) Int. Cl. G02B 3/08; G02B 5/00; G02B 27/28

(52) U.S. Cl. CPC G02B 3/08; G02B 5/001; G02B 27/283

(57) ABSTRACT

A lens has an optical center and an optical axis passing through the optical center, and at least a first lens portion positioned at a distance away from the optical center for refracting light rays of a predefined polarization state impinging at right angle thereto from a first side towards the optical axis on a second side at a constant bending angle thereby defining a focal line on the second side along the optical axis.

### CROSS-REFERENCE TO RELATED APPLICATION

This application claims priority to and benefit of U.S. Patent Application No. 63/320,589 filed on Mar. 16, 2022, which is hereby incorporated by reference in its entirety.

### FIELD OF THE DISCLOSURE

The present disclosure relates generally to imaging apparatus, and in particular to bijective illumination collection ellipsometry (BICE) apparatus and method for high-resolution imaging and polarimetry.

### BACKGROUND

Lenses have been widely used in fields of imaging. Generally, a converging lens is associated with a focal point defined along an optical axis of the lens, which determines the position of a light sensor or light detector (denoted “focused sensor position”, which defines an image plane) for capturing a focused or clear image of an object at a certain distance (denoted “focused object position” hereinafter). Examples of light sensors may be eyes, photosensitive materials such as camera films, photoelectrical sensors, and the like.

The captured image would be blurred if the light sensor is offset from the focused sensor position or the object is offset from the focused object position. In prior art, the depth-of-focus (DOF) of a lens refers to a range about the focused sensor position (which may be characterized by a corresponding range about the focal point) within which the captured image may be blurred (when the light sensor is offset from the focused sensor position) but within an acceptable extent and still providing an acceptable sharpness (for example, blurred but perceptually clear). An extended depth-of-focus (EDOF) allows the object to be positioned within an extended object range about the focused object position while still obtaining an acceptable image.

High-resolution microscopic imaging of tissue microstructures is instrumental to biology and enables numerous clinical applications. Microscopic imaging in three dimensions enables numerous biological and clinical applications. However, high-resolution optical imaging preserved in a relatively large depth range is hampered by the rapid spread of tightly confined light due to diffraction. As known in the art, optical microscopy using tightly focused light cannot be maintained in a relatively large depth range due to rapid spread of light dictated by diffraction. Imaging modalities such as confocal (see Reference 1) and two-photon (see Reference 2) microscopies achieve high-resolution imaging only from a narrow region around a focal point. Thus, additional scanning mechanisms are necessary to axially translate the focal point with respect to the target for depth-resolved imaging (see Reference 3). This impedes rapid imaging and the imaging depth, often limited to a few hundred microns (see Reference 4), is inadequate for many applications.

Using coherence gating, optical coherence tomography (OCT) captures real-time depth-resolved images of structures millimeters deep into the scattering tissue (see References 5-9). Though addressing axial resolution, OCT is still challenged by the competing lateral resolution and depth-of-focus due to diffraction that impedes high-resolution imaging in three-dimensions in a large depth range (see References 10-12).

The central question is how light intensity should be distributed to obtain high-resolution imaging in three-dimensions within a large depth range. Focusing light on a single depth point, widely used in the existing imaging systems, yields arbitrary primacy to that point which is inconsistent with the goal of depth imaging. Alternatively, more equitable distribution of the optical intensity along the axial direction inevitably compromises lateral resolution due to diffraction.

Ellipsometry is the measurement of optical polarization-altering properties of a substance or a system (see Reference 60). An optically linear substance or system may be characterized by a 4×4 Mueller matrix (M) which transforms incident light with a Stokes vector Sᵢₙ to (reflected, transmitted, or scattered) light with a Stokes vector Sₒᵤₜ (Sₒᵤₜ=M×Sᵢₙ). If the substance or system does not depolarize light, a 2×2 Jones matrix (J) may provide a complete description of the polarization-altering properties of the substance or the system. Determination of M and J requires at least four and three measurements, respectively.

Traditionally, ellipsometry has been conducted by recording multiple measurements and post-processing of the measured values. However, this method is slow due to sequential nature of the measurements. Real-time imaging of biological substance or tissue in vivo calls for a fast method for ellipsometry. Rotating-compensator ellipsometry (see Reference 61) has been reported for fast ellipsometry, however, in principle, it still is a sequential method and involves moving parts which complicates the design.

### SUMMARY

According to one aspect of this disclosure, there is provided a lens comprising: an optical center and an optical axis passing through the optical center; and one or more lens portions; the one or more lens portions comprise at least a first lens portion for refracting light rays of a predefined polarization state impinging at right angle thereto from a first side towards the optical axis on a second side at a constant bending angle thereby defining a focal line on the second side along the optical axis.

In some embodiments, the at least first lens portion is positioned at a distance away from the optical center.

In some embodiments, the at least first lens portion comprises the first lens portion and a second lens portion; centers of the first and second lens portions are on diagonally opposite sides of the optical center; and the first and second lens portions are configured for passing therethrough the light rays of orthogonal polarization states.

In some embodiments, the one or more lens portions further comprise: at least a third lens portion for refracting light rays impinging at the constant bending angle thereto from the focal line on the second side to the first side at a direction parallel to the optical axis.

In some embodiments, the at least a third lens portion comprises the third lens portion and a fourth lens portion; centers of the third and fourth lens portions are on diagonally opposite sides of the optical center; and the third and fourth lens portions are configured for passing therethrough the light rays of orthogonal polarization states.

In some embodiments, for a two-dimensional (2D) coordinate system defined on the lens with the origin thereof at the optical center, each of the one or more lens portions is positioned in a respective quadrant of the 2D coordinate system.

In some embodiments, centers of each circumferentially neighboring pair of the one or more lens portions are at right angle with respect to the optical center.

In some embodiments, the bending angle is 21°.

In some embodiments, each of the one or more lens portions has a circular shape.

In some embodiments, each of the one or more lens portions has a diameter of 1.1 millimeters (mm).

In some embodiments, each of the one or more lens portions comprises a metasurface coupled to a substrate.

In some embodiments, each metasurface comprises a plurality of nano-pillars in a pattern of arcs, said arcs being portions of a plurality of concentric circles centered at the optical center. In some embodiments, the plurality of nano-pillars have cubical shapes with square cross-sections; and the plurality of nano-pillars have a same height and varying widths.

In some embodiments, the widths of the plurality of nano-pillars are between 80 nanometers (nm) and 300 nm.

In some embodiments, the height of the plurality of nano-pillars is 750 nm.

In some embodiments, the neighboring pair of plurality of nano-pillars have a center-to-center distance of 370 nm.

In some embodiments, the lens further comprises an axicon with the vertex thereof being the optical center; and the one or more lens portions are defined on the axicon.

In some embodiments, the lens is opaque except at the one or more lens portions.

According to one aspect of this disclosure, there is provided an imaging apparatus comprising: a polarizing beam splitter for splitting a light ray into a first polarized light ray and a second polarized light ray of orthogonal polarization states; a beam conditioning module for receiving the first and second polarized light rays and outputting the first and second polarized light rays to the lens of any one of claims 1 to 17; and an adjustment module for introducing time delay to and/or for adjusting frequency of at least one of the first and second polarized light rays before the first and second polarized light rays are input into the beam conditioning module.

In some embodiments, the lens is the above-described lens; the beam conditioning module comprises: a main knife-edge prism, a first knife-edge prism for direction the first polarized light ray towards the main knife-edge prism, and a second knife-edge prism for direction the second polarized light ray towards the main knife-edge prism; and the main knife-edge prism is configured for: outputting the first and second polarized light rays towards a lens, receiving a third light ray and a fourth light ray from the lens, directing the third light ray towards the first knife-edge prism, and directing the fourth light ray towards the second knife-edge prism.

According to one aspect of this disclosure, there is provided a method of fabricating the above-described lens, the method comprising: depositing an amorphous silicon (a-Si) layer is on the substrate using a plasma-enhanced chemical vapor deposition; coating a layer of negative tone photoresist on the a-Si layer; using electron beam lithography (EBL) to create an etching pattern on the layer of negative tone photoresist; and using deep reactive ion etching to generate a-Si nano-pillars for forming the metasurfaces of the one or more lens portions.

In some embodiments, the etching pattern corresponds to the pattern of arcs.

In some embodiments, the etching pattern corresponds to the plurality of concentric circles. In some embodiments, the method further comprises: masking the one or more unusable areas to opaque.

According to one aspect of this disclosure, there is provided a method of using the lens of claim 5 or any one of claims 6 to 17, the method comprising at least one of: aiming a first light beam to the first lens portion; and collecting a third light beam and a fourth light beam from the third lens portion and the fourth lens portion, respectively; the first light beam has a cross-sectional size matching a size of the first lens portion.

According to one aspect of this disclosure, there is provided a lens comprising: an optical center and an optical axis passing through the optical center; and a plurality of lens portions comprising a first lens portion and a second lens portion on diagonally opposite first and second quadrants of a plane perpendicular to the optical axis for refracting light rays from a first side to a second side, and a third lens portion on a third quadrant of the plane for refracting light rays from the second side to the first side; the first and second lens portions are configured for refracting light rays impinging at right angle thereto from the first side towards the optical axis on the second side at a constant bending angle thereby defining a focal line on the second side along the optical axis, and the third lens portion is configured for refracting light rays impinging from the focal line on the second side at the constant bending angle thereto to the first side parallel to the optical axis; or the third lens portion is configured for refracting light rays impinging at right angle thereto from the second side towards the optical axis on the first side at the constant bending angle thereby defining the focal line on the first side along the optical axis, and the first and second lens portions are configured for refracting light rays impinging from the focal line on the first side at the constant bending angle thereto to the second side parallel to the optical axis.

In some embodiments, the plurality of lens portions are away from the optical center.

In some embodiments, centers of the first and third lens portions or the centers of the second and third lens portions are at right angle with respect to the optical center.

In some embodiments, the plurality of lens portions further comprises: a fourth lens portion on a fourth quadrant of the plane for refracting light rays impinging from the focal line on the second side at the constant bending angle thereto to the first side parallel to the optical axis; or for refracting light rays impinging at right angle thereto from the second side towards the optical axis on the first side at the constant bending angle thereby towards the focal line on the first side.

In some embodiments, the bending angle is 21°.

In some embodiments, each of the one or more lens portions has a circular shape.

In some embodiments, each of the one or more lens portions has a diameter of 1.1 mm.

In some embodiments, each of the one or more lens portions comprises a metasurface coupled to a substrate.

In some embodiments, each metasurface comprises a plurality of nano-pillars in a pattern of arcs, said arcs being portions of a plurality of concentric circles centered at the optical center.

In some embodiments, the plurality of nano-pillars have cubical shapes with square cross-sections; and the plurality of nano-pillars have a same height and varying widths.

In some embodiments, the widths of the plurality of nano-pillars are between 80 nm and 300 nm.

In some embodiments, the height of the plurality of nano-pillars is 750 nm.

In some embodiments, the neighboring pair of plurality of nano-pillars have a center-to-center distance of 370 nm.

In some embodiments, the lens comprises an axicon with the vertex thereof being the optical center; and the one or more lens portions are defined on the axicon.

In some embodiments, the lens is opaque except at the one or more lens portions.

### BRIEF DESCRIPTION OF THE DRAWINGS

FIG. 1A is a schematic plan view of a bijective illumination collection imaging (BICI) lens according to some embodiments of this disclosure, wherein the BICI lens comprises an illumination lens portion and a collection lens portion, and wherein the centers of the illumination and collection lens portions of the BICI lens are at 900 angle with respect to the optical center of the BICI lens;

FIG. 1B shows the detail of the illumination lens portion the BICI lens shown in FIG. 1A according to some embodiments of this disclosure, wherein the illumination lens portion comprises a metasurface;

FIG. 1C is a schematic diagram of the BICI lens shown in FIG. 1A, illustrating the pattern of the metasurfaces of the illumination and collection lens portions;

FIGS. 2A to 21 show the interaction of the BICI lens shown in FIG. 1A with illumination lights and collected lights, wherein FIG. 2A is a schematic perspective view of the BICI lens shown in FIG. 1A, showing an illumination ray impinging at right angle on the illumination lens portion of the BICI lens shown in FIG. 1A at a point off the imaging optical axis, the illumination lens portion bending or refracting the illumination ray by a constant angle β to form a focal point on the z-axis,

FIG. 2B is a schematic perspective view of the BICI lens shown in FIG. 1A, showing a ray family or ray sheet impinging at positions of an arc of radius r on the illumination lens portion of the BICI lens shown in FIG. 1A, the illumination lens portion bending or refracting the ray sheet by a constant angle β to form a focal point on the z-axis,

FIG. 2C is a schematic perspective view of the BICI lens shown in FIG. 1A, showing that ray sheets subject to the same bending paradigm impinging at positions on the illumination lens portion of the BICI lens shown in FIG. 1A constitute a focal line along the z-axis, the focal line is continuous even though a finite number of focal points is illustrated in FIG. 2C for clarity,

FIG. 2D is a schematic perspective view of the BICI lens shown in FIG. 1A, showing the collection lens portion of the BICI lens shown in FIG. 1A establishing trajectories of collected light in ray sheets, mirroring images of illumination paths with respect to the x-z plane, thereby enabling a one-to-one correspondence (that is, a bijective relationship) between the focal points of the illumination and collection paths, to eliminate out-of-focus signals,

FIG. 2E is an enlarged schematic perspective view of the portion A of FIG. 2D which manifests the bijective relationship,

FIG. 2F is a schematic plan view showing the illumination and collection beams,

FIG. 2G is a schematic diagram showing the setup of an experiment for verifying the optical characteristics of the BICI lens shown in FIG. 1A,

FIG. 2H shows a snapshot captured by a camera at a lateral plane intersecting the focal line shown in FIG. 2G, illustrating the arrangement of illumination and collection paths which allows only the collection of photons originating from the corresponding illumination focal point, and

FIG. 2I is a schematic diagram of the BICI lens shown in FIG. 1A, showing the length of the focal line and the distance between the focal line and the BICI lens;

FIGS. 3A to 3F show the metasurfaces of the illumination and collection lens portions, wherein

FIG. 3A is a schematic perspective view of a nano-pillar of the metasurfaces,

FIG. 3B is a schematic side view of the nano-pillar shown in FIG. 3A,

FIG. 3C is a schematic plan view of the nano-pillar shown in FIG. 3A,

FIG. 3D is a schematic plan view of nano-pillars of the metasurfaces, showing the nano-pillars having periodically varying sizes and in a lattice pattern for forming a pattern of arcs or circles,

FIG. 3E is a widefield optical image of the fabricated metasurfaces of the illumination and collection lens portions, each of which has a diameter of 1.1 millimeters (mm), and

FIG. 3F is a scanning electron micrograph of the fabricated metasurfaces of the illumination and collection lens portions comprising square amorphous silicon (a-Si) nano-pillars;

FIG. 4 shows the analytic point spread function (PSF) of the BICI lens shown in FIG. 1A, showing that the BICI lens has a lateral resolution of about 3.2 micrometers (μm) and a focal line or depth-of-focus of about 1.25 mm;

FIGS. 5A to 5C show the analytic PSF of conventional technologies using common path Gaussian and Bessel beams, wherein

FIG. 5A shows that the PSF of a tightly focused Gaussian beam (about 3.2 μm full-width at half maximum (FWHM)) rapidly degrades away from the focal point,

FIG. 5B shows that the PSF of a Gaussian beam with a relatively large depth-of-focus (about 1.25 mm) assumes greatly compromised lateral resolution, and

FIG. 5C shows that the PSF of a Bessel beam with 3.2 μm FWHM of central lobe involves spread of power into several side-lobes detrimental to imaging quality;

FIG. 6 is a schematic diagram of an interferometer incorporating the BICI lens shown in FIG. 1A in one arm thereof, according to some embodiments of this disclosure;

FIGS. 7A to 7C show the test result using the interferometer shown in FIG. 6, wherein

FIG. 7A shows the intensity distribution measurements of the illumination beam of 1300 nm wavelength in the x-z plane,

FIG. 7B shows intensity distribution measurements of the collection beam of 1300 nm wavelength in the x-y plane, and

FIG. 7C shows the imaging PSF, which is the product of the illumination and collection intensity profiles, indicating the maintenance of a sharp PSF in a large axial range;

FIGS. 8A to 8C show the resolution and depth-of-focus measurement of the BICI lens shown in FIG. 1, wherein

FIG. 8A is a schematic diagram of the measurement setup for imaging a subwavelength gold line being scanned across the focal line at various depth points,

FIG. 8B shows the measured imaging PSF at three depth points, and

FIG. 8C shows the measured resolution of the BICI lens shown in FIG. 1 compared to the theoretical resolution obtained from a Gaussian beam (in a common path illumination-collection scheme) of the same lateral resolution, thereby highlighting the ability of the BICI lens shown in FIG. 1 to maintain high resolution in a large depth range;

FIG. 9A is a schematic plan view of a BICI lens according to some embodiments of this disclosure, wherein the centers of the illumination and collection lens portions of the BICI lens are at an angle smaller than 900 with respect to the optical center of the BICI lens;

FIG. 9B is a schematic plan view of a BICI lens according to some embodiments of this disclosure, wherein the centers of the illumination and collection lens portions of the BICI lens are at an angle greater than 90° with respect to the optical center of the BICI lens;

FIGS. 10A to 10D show a BICI lens according to some embodiments of this disclosure, wherein

FIG. 10A is a schematic plan view of the BICI lens, wherein the illumination and collection lens portions of the BICI lens are in diagonally opposite quadrants of the BICI lens,

FIG. 10B is a schematic plan view of the BICI lens shown in FIG. 10A, showing the illumination and collection beams,

FIG. 10C is a schematic perspective view of the BICI lens shown in FIG. 10A, showing the illumination and collection paths, and

FIG. 10D is an enlarged schematic perspective view of the portion B of FIG. 10D which manifests the bijective relationship;

FIG. 11A is a schematic plan view of a BICI lens according to some embodiments of this disclosure, wherein the BICI lens comprises two illumination lens portions and one collection lens portion;

FIG. 11B is a schematic plan view of a BICI lens according to some embodiments of this disclosure, wherein the BICI lens comprises one illumination lens portion and two collection lens portions;

FIG. 12 is a schematic plan view of a BICI lens according to some embodiments of this disclosure, wherein the BICI lens comprises two illumination lens portions and two collection lens portions;

FIGS. 13A and 13B show the comparison of the resolution of the BICI lens shown in FIG. 1A (see FIG. 13A) and that of the BICI lens shown in FIG. 12 (see FIG. 13B);

FIGS. 14A and 14B show a fabrication process of the BICI lens shown in FIG. 1A, according to some embodiments of this disclosure;

FIG. 15 is a schematic plan view of a BICI lens according to some embodiments of this disclosure, wherein the BICI lens comprises a metasurface with a pattern of a plurality of concentric circles centered at the optical center, and wherein, when in use, an illumination beam may be aimed at a first area to use it as the illumination lens portion and a light collector may be aimed at a second area to use it as the collection lens portion;

FIG. 16 is a schematic plan view of a BICI lens according to some embodiments of this disclosure, wherein the BICI lens has a square shape;

FIG. 17 is a schematic plan view of a BICI lens according to some embodiments of this disclosure, wherein the optical center of the BICI lens does not overlap with the geometrical center of the BICI lens;

FIG. 18 is a schematic plan view of a BICI lens according to some embodiments of this disclosure, wherein the BICI lens comprises four circular-shape lens portions each having a maximized size in the corresponding quadrant;

FIG. 19A is a schematic perspective view of a BICI lens according to some embodiments of this disclosure, wherein the BICI lens comprises an axicon;

FIG. 19B is a schematic plan view of the BICI lens shown in FIG. 19A;

FIG. 20A is a schematic plan view of a BICI lens according to some embodiments of this disclosure, wherein the BICI lens comprises a collection lens portion;

FIG. 20B is a schematic perspective view of the BICI lens shown in FIG. 20A and a line camera for collecting light rays from various focal points within the focal line of the BICI lens;

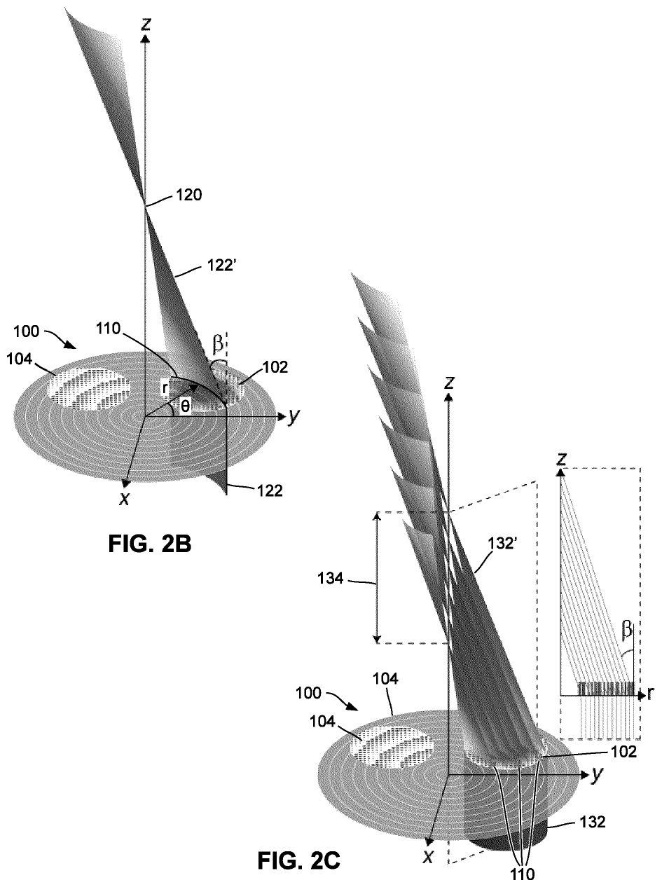

FIG. 2I is a schematic diagram showing a bijective illumination collection ellipsometry (BICE) lens for rapid high-resolution ellipsometry, according to some embodiments of this disclosure;

FIG. 22 is a schematic perspective view of the BICE lens shown in FIG. 2I for focusing a pair of illumination light rays toward the focal line thereof, according to some embodiments of this disclosure;

FIG. 23 is a schematic perspective view of the BICE lens shown in FIG. 2I for focusing a pair of illumination light rays toward a focal line thereof and for collecting light rays from the focal line thereof, according to some other embodiments of this disclosure;

FIG. 24 is a schematic perspective view of the BICE lens shown in FIG. 2I for focusing an illumination light ray toward the focal line thereof, according to yet some other embodiments of this disclosure;

FIG. 25 is a schematic perspective view of the BICE lens shown in FIG. 2I for focusing an illumination light ray toward the focal line thereof and for collecting light rays from the focal line thereof, according to still some other embodiments of this disclosure;

FIG. 26 is a schematic perspective view of the BICE lens shown in FIG. 2I for focusing an illumination light ray toward the focal line thereof, according to some other embodiments of this disclosure;

FIG. 27 is a schematic perspective view of the BICE lens shown in FIG. 2I for focusing an illumination light ray toward the focal line thereof and for collecting light rays from the focal line thereof, according to still some embodiments of this disclosure;

FIG. 28 is a schematic diagram showing an ellipsometry system using the BICE lens shown in FIG. 2I with introduction of time delays to the light rays therein;

FIG. 29 is a schematic diagram showing an ellipsometry system using the BICE lens shown in FIG. 2I with frequency adjustment to the light rays therein;

FIG. 30 is a schematic perspective view of the beam conditioning module of the ellipsometry system shown in FIG. 28 or 29;

FIG. 31A is a schematic perspective view of the beam conditioning module of the ellipsometry system shown in FIG. 28 or 29, showing the path of the illumination light rays; and

FIG. 31B is a schematic perspective view of the beam conditioning module of the ellipsometry system shown in FIG. 28 or 29, showing the path of the collection light rays.

### DETAILED DESCRIPTION

Embodiments disclosed herein relate to a bijective illumination collection imaging (BICI) apparatus and method for high-resolution imaging in three dimensions within a relatively large depth range.

According to one aspect of this disclosure, there is provided a lens having a focal line defined along an optical axis of the lens. Light rays impinging various positions of the lens at an angle parallel to the optical axis are converged by the lens to various positions within the focal line. Therefore, such a lens with a focal line provides an improved depth-of-focus (DOF) such that a light sensor positioned anywhere within the improved DOF thereof may capture clear images (that is, images of high resolution). In comparison, images captured using conventional extended depth-of-focus (EDOF) technologies may still be blurred or with reduced resolution.

According to one aspect of this disclosure, high-resolution imaging is achieved through a particular disposition of illumination and collection paths that allows a one-to-one spatial correspondence (bijection) between the illumination and collection light defined along a focal line, thereby liberating optical imaging from the restrictions imposed by diffraction. The impact on imaging is demonstrated by applying BICI to overcome the limitations in high-resolution optical coherence tomography (OCT).

The boundaries of lateral resolution and depth-of-focus are coupled by diffraction. There exists a class of so-called diffraction-free (see References 18-23) solutions to the Helmholtz equation. However, these modes in their exact mathematical forms have spatially unbounded profiles (plane waves are a trivial example) and give rise to side-lobes that carry a significant portion of the optical power (even in their physical realizations limited by a finite aperture). When used for imaging, the out-of-focus scattering from the side-lobes compromises imaging resolution and sensitivity.

Revisiting lateral resolution and depth-of-focus in the context of imaging point spread function (PSF) provides opportunities to evade the restrictions imposed by diffraction. The PSF at any point is the product of the probabilities of photons illuminating (Pᵢₙ) and collected from (P_{coll}) that point: PSF=Pᵢₗₗ×P_{coll} (see References 24-25). Based on this notion, it is possible to decouple lateral resolution from depth-of-focus using uniquely crafted illumination and collection paths. Herein, the illumination path refers to the path of light rays impinging on an object from a light emitting source, and the collection path refers to the path of light rays scattered from or otherwise originated from the object.

In some embodiments, metasurfaces (see References 13-17) with the ability to impart tailored phases are used to realize the illumination and collection paths required for the implementation of BICI. In some embodiments, a lateral resolution of about 3.2 micrometers (μm) is maintained nearly intact over 1.25 mm imaging depth with no additional acquisition or computation burden, giving rise to about 12-fold larger imaging depth-of-focus compared to that obtained using an ideal Gaussian beam with the same lateral resolution. Imaging swine tracheobronchial tissue specimens indicates the BICI's prospect for high-resolution imaging preserved within a large depth range. The method disclosed herein may be adapted across various existing imaging modalities.

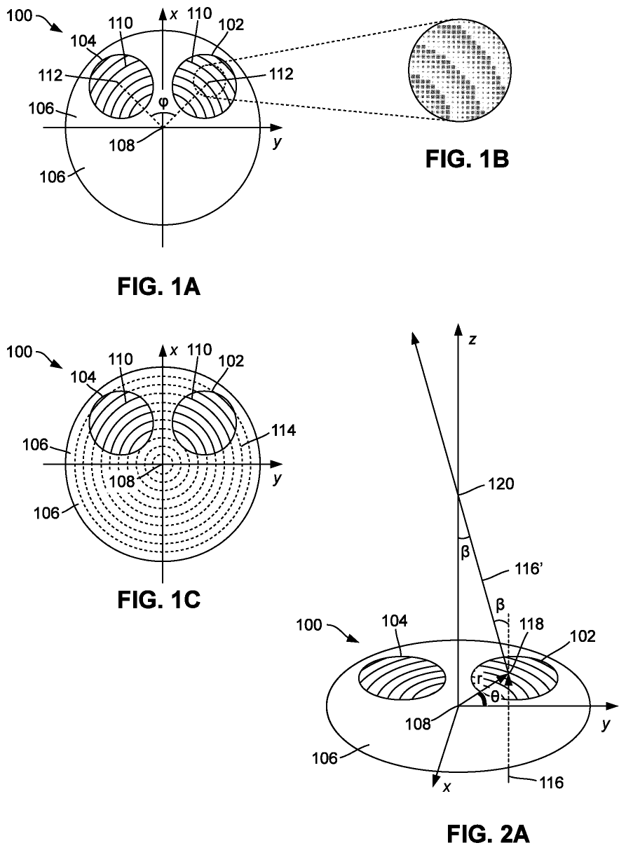

Turning now to FIGS. 1A to 1C, a BICI lens according to some embodiments of this disclosure is shown and is generally identified using reference numeral 100. For ease of illustration, a three-dimensional (3D) coordinate system is defined with the x-y plane on the BICI lens 100 and the z-axis (see FIG. 2A) being the optical axis of the BICI lens 100 and passing through an optical center 108 thereof (that is, the origin of the 3D coordinate system is at the optical center 108). In these embodiments, the optical center 108 is also the centroid or geometrical center of the BICI lens 100.

As shown in FIGS. 1A to 1C, the BICI lens 100 comprises an illumination lens portion 102 and a collection portion 104 on the x-y plane of the BICI lens 100 for allowing light rays to pass therethrough. The illumination and collection lens portions 102 and 104 preferably have circular shapes of a same size.

Each of the illumination and collection lens portions 102 and 104 are positioned at a distance away from the optical axis. More specifically, for the two-dimensional (2D) x-y coordinate system, the illumination and collection lens portions 102 and 104 are positioned in neighboring quadrants of the x-y plane and symmetric about one of the axes such as the x-axis on the BICI lens 100, such that the center 112 of each of the illumination or collection lens portions 102 and 104 with respect to the optical center 108 is at φ=45° to the x-axis. In other words, the centers 112 of the illumination and collection lens portions 102 and 104 are at 900 with respect to the optical center 108. For the purpose of noise reduction, it is preferable that, except the illumination and collection lens portions 102 and 104, the other area of the BICI lens 100 (denoted in FIGS. 1A to 1C as the area 106) is opaque, therefore rendering it unusable.

In these embodiments, each lens portion 102, 104 comprises a metasurface formed by arrays of nanoscale, subwavelength-spaced optical elements (denoted “nano-pillars”) as shown in FIG. 1B. The two metasurfaces 102, 104 have mirrored profiles (that is, mirrored geometry of nano-pillars) about the x-axis. In other words, the metasurface of the collection lens portion 104 has a flipped profile of the metasurface of the illumination lens portion 102 with respect to the x-axis. More specifically, each of the metasurfaces of the lens portions 102 and 104 has a pattern of arcs 110 being portions of a plurality of concentric circles 114 centered at the optical center 108 (see FIG. 1C).

As shown in FIG. 2A, a collimated light source (not shown) emits an illumination light ray 116 impinging at right angle on the illumination lens portion 102 at a point 118 thereof having the coordinates (r, θ), where r is the radius of the point 118 (with respect to the optical center 108) and 0 is the angle of the point 118 with respect to the y-axis. The metasurface of the illumination lens portion 102 bends or refracts the light ray 116 incident at the point 118 by a constant angle β in the r-z surface towards the optical axis (that is, z-axis). A focal point 120 may be defined as the intersection point of the refracted ray 116′ and the optical axis.

The light-ray-bending angle β is constant with respect to r and θ. Therefore, as shown in FIG. 2B, a ray family of light rays 122 incident on the arc 110 of radius r (denoted a “ray sheet of radius r”) cross the focal point 120 on the z-axis (that is, focused at the focal point 120). Therefore, as shown in FIG. 2C, a light beam or a group of light ray families 132 impinging at right angles on the illumination metasurface 102 at the arcs 110 of constant but different radii are generally focused within a continuous focal line 134 along the optical axis.

As the collection metasurface 104 has a flip profile of the illumination metasurface 102 with respect to the x-axis, the illumination metasurface 102 has similar optical characteristics as the illumination metasurface 102. As shown in FIGS. 2D and 2E, ray sheets 142 originated from the focal line 134 at the constant angle β in the r-z surface with respect to the optical axis imping on the illumination metasurface 102 at the arcs 110 of constant radii, which is then refracted to form a light beam 142′ parallel to the optical axis. A snapshot of the illumination and collection beams in one of the lateral planes intersecting the focal line 134 is illustrated in FIG. 2F. Clearly, with above-described structure of the BICI lens 100, the BICI lens 100 provides separated illumination path 132-132′ and collection path 142-142′ overlapping only on the focal points along the focal line 134.

Although light beams 132 and 142 with any suitable cross-sectional sizes may be used, the light beams 132 and 142 preferably have the same size as that of the illumination and collection lens portions 102 and 104 for best optical efficiency. Therefore, the size of the illumination or collection lens portion 102 or 104 is also denoted as the beam size hereinafter.

As an example, FIG. 2G is a schematic diagram showing the setup of an experiment for verifying the optical characteristics of the BICI lens 100, wherein two light beams 132 and 142′ are aimed at the illumination and collection lens portions 102 and 104, respectively, at right angle. As described above, the light beams 132 and 142′ are focused by the BICI lens 100 at the focal line 134. An image sensor (such as a camera; not shown) located on a lateral plane 144 intersecting the focal line 134 captures the image 152 of the ray sheets 132′ and 142. As shown in FIG. 2H, the ray sheets 132′ and 142 are focused at the point or dot 154 in the captured image 152.

Remarkably, the BICI lens 100 yields invariant lateral resolution (determined by P) along the focal line 134. The lateral resolution is dictated solely by the bending angle β (regardless of the beam size) based on wave analyses using a Fresnel-Kirchhoff integral (see Reference 26). Depth-of-focus or the focal line 134, however, depends on both the bending angle β and the beam size according to the simple geometry shown in FIG. 2I, wherein the distance between the BICI lens 100 and focal line 134 is about R(√2−1)/tan(β), and the length of the focal line 134 is about 2R/tan(P).

Thus, the desired depth-of-focus and the bending angle β (set from the desired resolution) yield the beam size such as the radius R thereof. In some embodiments, the calculation shown in FIG. 2I, which is based on ray optics, may be combined with wave analyses for obtaining a more accurate account of depth-of-focus 134.

The BICI lens 100 establishes a one-to-one correspondence or a bijective relationship defined exclusively on the focal line 134 between the points illuminated and points from which light is collected, eliminating out-of-focus signals and back-reflection signals. The separated illumination path 132-132′ and collection path 142-142′ ensure that the illumination beam for illuminating points on the focal line 134 and the collection beam collected from the illuminated points on the focal line 134 do not overlap.

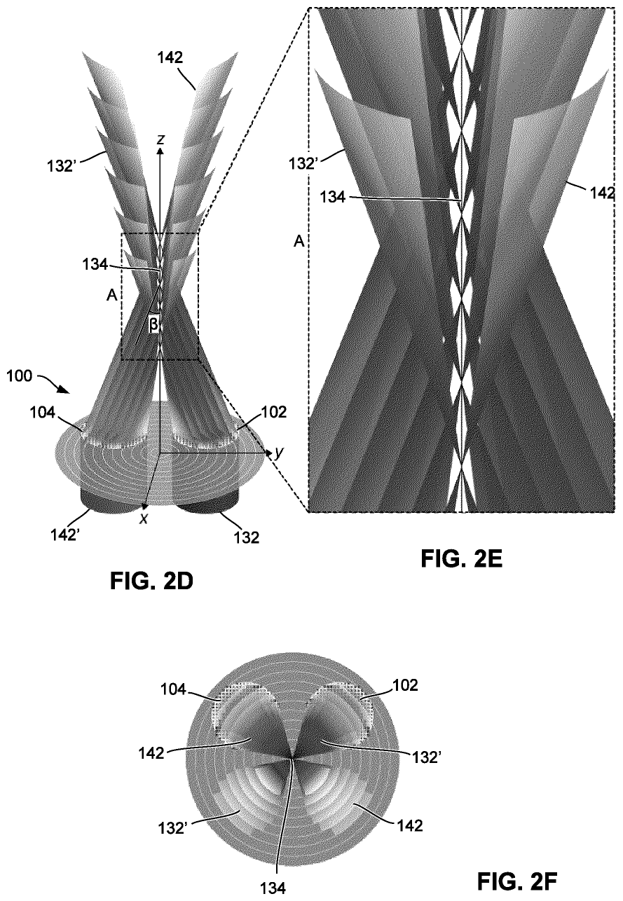

As described above, the illumination and collection lens portions 102 and 104 may comprise metasurfaces. The distribution and geometry of pillars on metasurfaces are engineered to realize the illumination and collection beams in BICI. Based on the generalized Snell's law (see Reference 13), the phase Φ required to bend ray sheets (as defined in FIG. 2B; that is, a ray family impinging the illumination lens portion 102 at positions of a same radius r) with the angle β in the r-z plane satisfies:

$$\frac{d Φ ( r )}{d r} = - \frac{2 π}{{λ}_{d}} sin ( β ) \qquad ( 1 )$$

where, in some embodiments, λ_{d}=1300 nm is the design wavelength, for example, corresponding to the center wavelength of an OCT source. Referring to FIGS. 3A to 3C, this phase was realized by the illumination lens portion 102 comprising a metasurface of square amorphous silicon (a-Si) nano-pillars 162 which yield a polarization-insensitive performance. Herein, a square nano-pillar refers to a nano-structure having a height H and a square cross-section (perpendicular to the height H; for example, along the cross-section line A-A shown in FIG. 3A) and the base size of a nano-pillar refers to its cross-section size. In these embodiments, the a-Si nano-pillars 162 have the same height.

For example, in some embodiments, the a-Si nano-pillars have the same height of H=750 nm. The a-Si nano-pillars may have square cross-sections with the widths S (which determines the base sizes thereof) between 80 nm and 300 nm which may provide a full phase range [0-2π] with high transmittance (greater than 78%) at the wavelength of 1300 nm. The a-Si nano-pillars are distributed in a lattice pattern of P=370 nm unit cells 166 (that is, the center-to-center distance between neighboring a-Si nano-pillars is P=370 nm).

Also shown in FIG. 3D, the square a-Si nano-pillars 162 are distributed on a glass (SiO₂) substrate 164 in a square lattice pattern. By periodically varying the base sizes of the nano-pillars 162, the arc or circular pattern 110 or 114 are then formed.

Nano-pillars of varying base sizes across the lattice impart the required local phase. Owing to its high refractive index and low absorption in the near infrared range (see References 29-31), a-Si is a suitable material to achieve efficient metasurfaces (greater than 70% of the incident power concentrated on the focal line 134) for this application. Metasurfaces may be fabricated on a glass substrate using electron beam lithography.

In particular, the metasurfaces of the illumination and collection lens portions 102 and 104 may be fabricated using a top-down lithography technique (see References 30 and 32). An a-Si layer (for example, a 750 nm thick a-Si layer) is deposited on a glass substrate using the plasma-enhanced chemical vapor deposition. Negative tone photoresist (Micro resist technology, ma-N 2403) is then coated on the a-Si layer and Electron beam lithography (EBL) is used to create the intended pattern, such as the pattern of the illumination and collection lens portions 102 and 104 shown in FIGS. 1A to 1C, on the negative tone photoresist. Deep reactive ion etching is then used to generate a-Si nano-pillars. The BICI lens 100 having the illumination and collection lens portions 102 and 104 is then fabricated.

FIG. 3E is a widefield optical image of the fabricated metasurfaces of the illumination and collection lens portions 102 and 104, and FIG. 3F shows a scanning electron micrograph of the fabricated metasurface comprising square amorphous silicon (a-Si) nano-pillars. The phase profiles of the metasurfaces are realized using a proper distribution of a-Si nano-pillars of varying base sizes.

Indispensable to high-resolution imaging, the BICI lens 100 rejects out-of-focus signals using the uniquely crafted illumination and collection paths 132-132′ and 142-142′ without compromising the depth range. Thus, the BICI lens 100 provides high lateral resolution within a large depth range. Moreover, the BICI lens 100 may capture the image of the entire depth range due to the focal line 134 created by the illumination and detection beams.

On the other hand, in the existing high-resolution imaging systems, the effect of out-of-focus signals is typically lessened using tightly focused light to comparatively increase the signal from the focal point (using a confocal geometry or nonlinear effects at the focal point). This approach inevitably limits the depth range due to severe diffraction of tightly focused light.

Unless rectified using special techniques (see References 33 to 37), metasurfaces often exhibit strong chromatic dispersion. Application of BICI to OCT operating at a broad wavelength range (1240 nm to 1350 nm) entails resolution of issues associated with chromatic dispersion. The bending angle β imparted to the ray paths (see FIG. 2B) by the metasurfaces is evidently wavelength dependent (Equation (1)). For BICI correct operation, the focal line 134 needs to remain on the optical axis in the entire spectrum in order to sustain the bijection between the focal points. The azimuthally symmetric phase profiles of the metasurfaces with respect to the optical axis, together with the infinity-corrected configuration of the optical system, ensure the displacement of focal points only along the optical axis (z-axis) due to chromatic dispersion. This, in turn, guarantees conservation of the bijective relation between illumination and collection light over the entire spectrum.

To demonstrate the impact on imaging, a BICI lens 100 is used in a Fourier-domain OCT system in the near infrared range. The illumination/collection beam has a wavelength λ=1300 nanometers (nm)±50 nm with a Gaussian distribution (350 μm 1/e² intensity fall-off radius). The illumination and collection lens portions 102 and 104 are centered at (x, y)=(550 μm, 550 μm) and (x, y)=(550 μm, +550 μm), respectively, according to the coordinates defined in FIG. 1A. Each of the illumination and collection lens portions 102 and 104 has a metasurface with a diameter of 1.1 millimeters (mm) and a bending angle β=21° (numerical aperture NA=0.36).

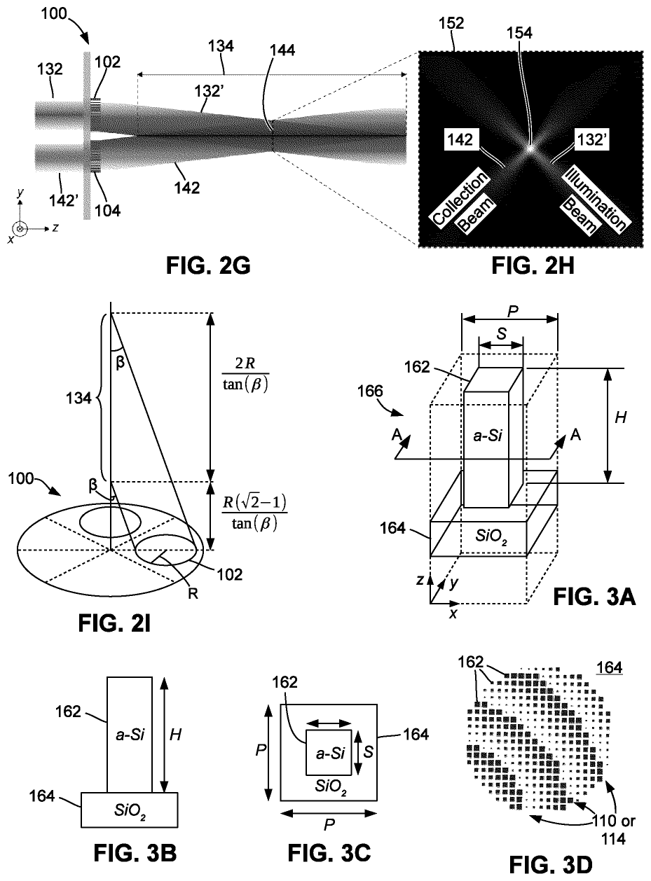

Wave analyses using a Fresnel-Kirchhoff integral (see Reference 26) were performed to engineer the imaging PSF needed for the intended resolution and depth-of-focus. Design parameters are selected to achieve microscopic resolution imaging in a relatively large depth range (greater than one (1) mm) beyond which scattering becomes the dominant limitation. Given the design parameters (collimated beam size about 1.1 mm; 1=21°), wave analyses yield a sharp PSF of 3.2 μm full-width at half maximum (FWHM) and a relatively large axial range of 1.25 mm depth-of-focus (defined as 1/e² PSF intensity fall-off in the axial direction) with negligible contributions from out-of-focus signals, as shown in FIG. 4.

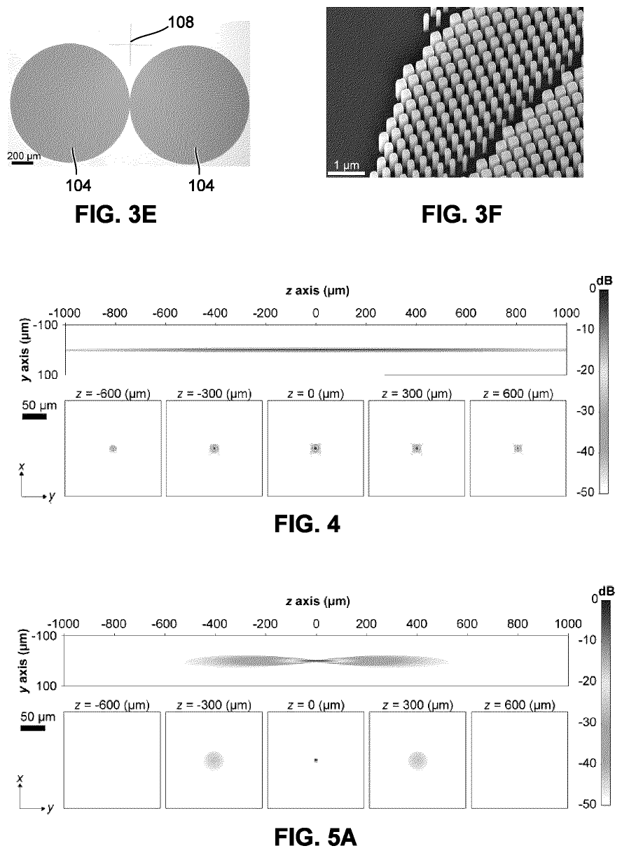

FIGS. 5A to 5C present the results of conventional approaches in terms of lateral resolution and depth-of-focus.

In particular, FIGS. 5A and 5B show the results of an imaging system with a conventional common path for illumination and collection using ideal Gaussian beams. As shown, the PSF of a tightly focused Gaussian beam (about 3.2 μm FWHM) rapidly degrades away from the focal point (FIG. 5A), and the PSF of a Gaussian beam with a relatively large depth-of-focus (about 1.25 mm) shows greatly compromised lateral resolution (FIG. 5B). Clearly, such a conventional imaging system with a lateral resolution comparable to that of the BICI lens 100 would have a significantly shortened depth-of-focus of 100 μm (see FIG. 5A). On the other hand, such a conventional imaging system with a depth-of-focus comparable to that of the BICI lens 100 would have a significantly compromised lateral resolution of 12 μm (see FIG. 5B).

FIG. 5C shows a Bessel beam with the same FWHM of the central lobe (3.2 μm) as that of the BICI lens 100. Such a Bessel beam, although offers an extended depth-of-focus, suffers from side-lobes that carry a significant portion of optical power (see References 27 and 28).

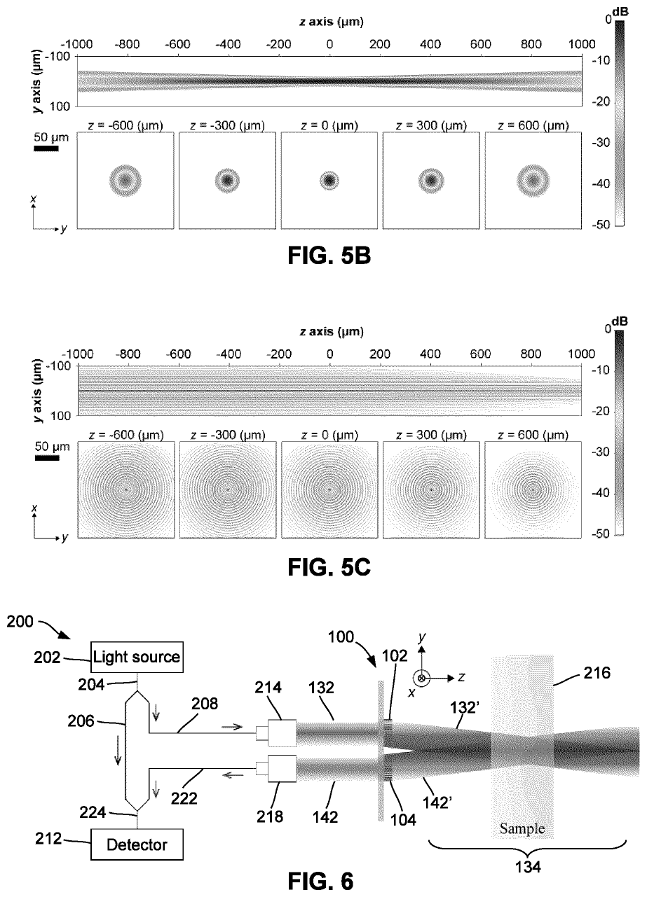

FIG. 6 shows an interferometer 200 using the BICI metasurface lens 100. As shown, the interferometer 200 comprises a light source 202 for emitting a light beam 204. The light beam 204 is split to two which go through a first path 206 towards a light detector 212 and a second path 208 towards the illumination path through a collimating lens assembly 214, respectively. The collimating lens assembly 214 forms the second-path light 208 to an illumination beam 132 towards the illumination lens portion 102 of the BICI lens 100. As described above, the illumination lens portion 102 of the BICI lens 100 refracts the illumination beam 132 such that the refracted illumination beam 132′ crosses the imaging optical axis at the focal line 134.

A target 216 such as a sample is axially positioned to overlap the focal line 134 which reflects the illumination beam 132′. The reflected light forms the collection beam 142′ towards the collection lens portion 104 of the BICI lens 100. The collection lens portion 104 refracts the collection beam 142′, and the refracted collection beam 142 is injected to the receiving lens assembly 218. The receiving lens assembly 218 passes the received light through a receiving light path 222 and combined with the first-path light 206. The combined light 224 is injected into the light detector 212.

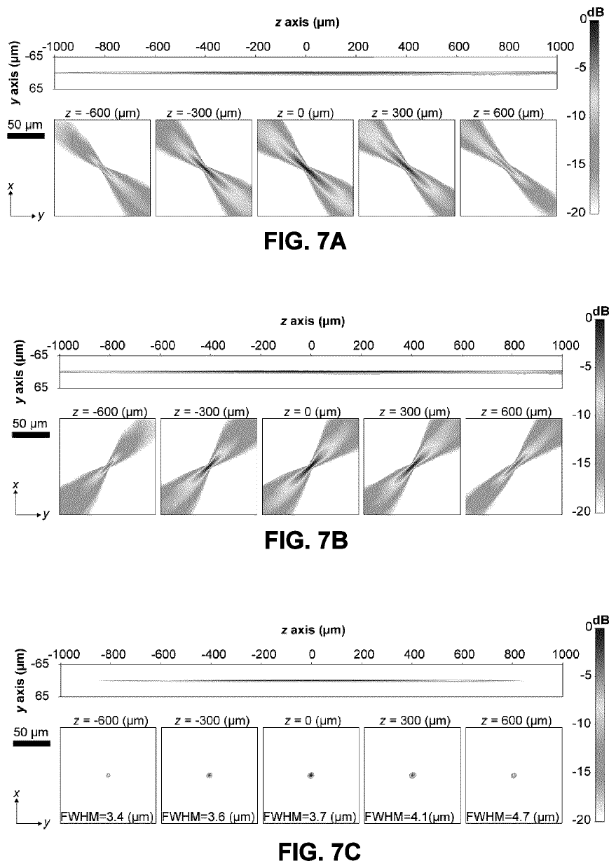

The intensity profiles of the illumination and collection beams 132 and 142 were measured. The measured illumination (see FIG. 7A) and collection (FIG. 7B) beams 132/132′ and 142/142′ form coincident focal lines 134 along the z-axis. FIG. 7C shows the imaging PSF (which is the product of the illumination and collection intensity profiles), indicating a sharp PSF with small FWHMs (about 3.7 μm at z=0) maintained over a relatively large depth range (about 1.22 mm), wherein the position z=0 is about 2 mm away from the BICI lens 100. These measurements are consistent with the results of wave analysis (3.2 μm FWHM; 1.25 mm depth-of-focus) shown in FIG. 4, though slight deviations exist likely due to the non-linear response of the camera, alignment imperfections of the optical setup, and/or fabrication errors. Despite the chromatic dispersion of the metasurfaces (see References 33-37), the focal lines 134 of the illumination and collection beams 132/132′ and 142/142′ remain aligned over the entire spectrum of the light source with no significant changes in the imaging PSF.

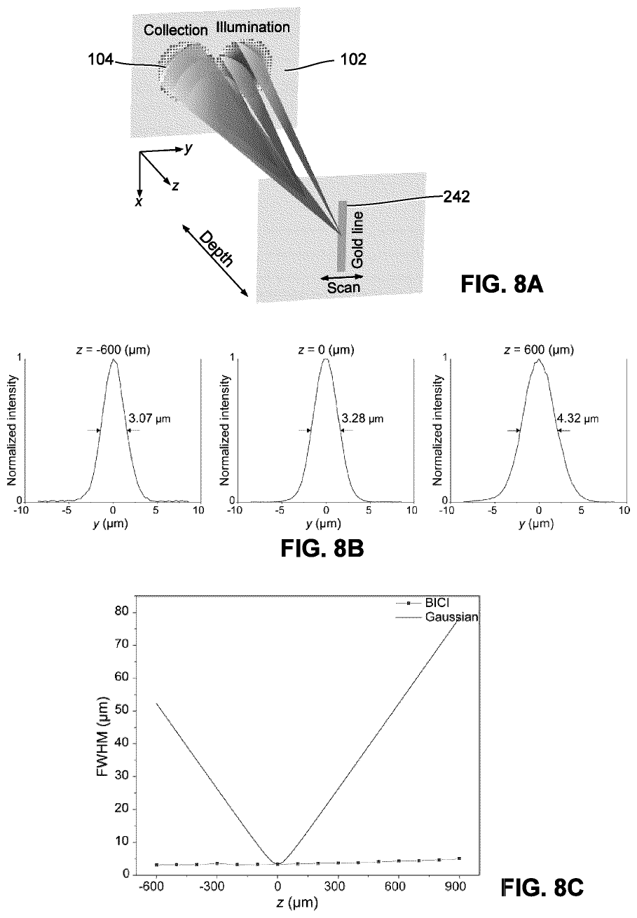

The BICI lens 100 was characterized in terms of lateral resolution and depth-of-focus through imaging a resolution target made of a subwavelength gold line (200 nm width and 50 nm height) fabricated on a glass substrate. The BICI lens 100 was coupled to an in-house Fourier-domain OCT system. As illustrated in FIG. 8A, lateral resolution and depth-of-focus were measured by scanning the gold line 242 across the focal line 134 (not shown) at varying target-metasurface distances. FIG. 8B shows the imaging PSF measured at three selected depth points.

FIG. 8C shows the measured resolution of the BICI lens 100 compared to the theoretical resolution obtained from a Gaussian beam (in a common path illumination-collection scheme) of the same lateral resolution, thereby highlighting the ability of the BICI lens 100 to maintain high resolution in a large depth range, wherein the position z=0 located about 2 mm away from the metasurfaces. Summarized in FIG. 8C, results indicate high lateral resolution (about 3.28 μm) maintained over more than 1.25 mm depth range, consistent with the wave analysis. To demonstrate the improvements, FIG. 8C also includes the analytical imaging PSF with an ideal Gaussian beam of the same lateral resolution that proves reduced imaging depth-of-focus (about 12 times) compared to that of the BICI lens 100.

There are also techniques in which mathematically optimized phase profiles are imparted using freeform metasurfaces to obtain maximum depth-of-focus (see References 40 to 43). Although these techniques can somewhat alleviate the issue through a modest increase in depth-of-focus (about 1.5 time to 2 times), they cannot be considered as a strategy to radically overhaul the limitations in the maintenance of high-resolution imaging across a relatively large depth range.

The BICI lens 100 entails no additional processing (see Reference 44) or acquisition (see Reference 10) burden and may be implemented across various wavelength ranges as its working principles remain unaltered with a wavelength change. For instance, the BICI lens 100 may be implemented in broadband OCT systems operating at shorter wavelengths with improved axial resolution. The wavelength range described herein is chosen to avoid increased scattering at shorter wavelengths that predominantly limits the imaging depth (see References 10, 45, and 46).

Various configurations of illumination and collection beams were previously reported in OCT (for speckle-reduction (see References 47 and 48) and deep tissue imaging (see Reference 49)), in two-photon microscopy (for enhanced signal-to-background ratio (see References 50 to 52)), in theta confocal (see References 25 and 53), 4pi (see Reference 54), and light sheet (see Reference 55) microscopy (for improved resolution), and dark-field microscopy (see Reference 56) (for enhanced sensitivity). These systems are designed to capture signals from a region neighboring a single focal point. Aa a result, imaging within a modest depth range entails either using very small (see References 47 to 49) (compromising lateral resolution) or physical translation of the target with respect to the imaging system (see Reference 25, and 50 to 56) (compromising imaging speed).

Sensibly, the optical arrangement for depth imaging with preserved lateral resolution should 1) focus light equitably along the depth range (on a focal line), and 2) reject out-of-focus signals originating from the points outside the focal line. Unlike the previous works, the optical arrangement of the BICI lens 100 meets both criteria, enabling imaging relatively large depth range along which the lateral resolution is maintained.

OCT, being a coherence imaging technique, comprises of speckles which are carriers of information and, at the same time, a source of noise (see Reference 57). The signal-degrading speckles are due mainly to the effects of multiple backscatters, while the signal-carrying speckles are the result of the single back-scattered component whose spatial frequency content extends to the diffraction limit of the imaging optics (see Reference 57). Scaling up proportionally to the spot size, the signal-carrying speckles originate from the focal zone and the signal-degrading speckle is created by out-of-focus light scattered multiple times. BICI lens 100 suffers considerably less from the effects of speckles due to: 1) its higher lateral resolution maintained along the depth range, resulting in notably smaller speckle sizes, 2) the ability to eliminate out-of-focus signal and, in turn, the effects of multiple scattering, and 3) the ability to reject back-reflection from imaging optics.

Pathological changes at early stages of diseases like cancers are often very subtle and can be easily overlooked. In vivo high-resolution imaging maintained in a large depth range has the potential to enable early and accurate detection and diagnosis. Being implemented using metasurfaces, the BICI lens 100 may be feasibly miniaturized into endoscopic devices (see References 58 and 59) for in vivo high-resolution imaging of internal organs.

The advent of high-resolution optical imaging techniques has impacted fundamental medical research as well as clinical applications. Expanding the scope of applications, however, necessitates overcoming major limitations in the current techniques. The diffraction-imposed trade-off between lateral resolution and depth-of-focus is circumvented through bijective illumination collection imaging, enabling high-resolution imaging in three dimensions. While the BICI metasurface lens 100 is applied to OCT in this disclosure, the underlying concept is general and the BICI metasurface lens 100 may be adapted across various imaging modalities such as confocal and two-photon microscopy.

Those skilled in the art will appreciate that various alternative embodiments are readily available. For example, although the metasurfaces in above embodiments comprise square nano-pillars 162, in various embodiments, the metasurfaces may comprise other suitable nano-structures such as nano-pillars with circular or elliptical cross-section.

In above embodiments, the arcs 110 or circles 114 are concentric (see FIG. 1C). In some embodiments, the arcs 110 or circles 114 may not be concentric.

Although the illumination and collection lens portions 102 and 104 in above embodiments have circular shapes of a same size. In alternative embodiments, the illumination and collection lens portions 102 and 104 may have any suitable shapes and sizes.

In some embodiments, the area 106 of the BICI lens 100 may be transparent or semi-transparent, but are prohibited or otherwise disallowed for use.

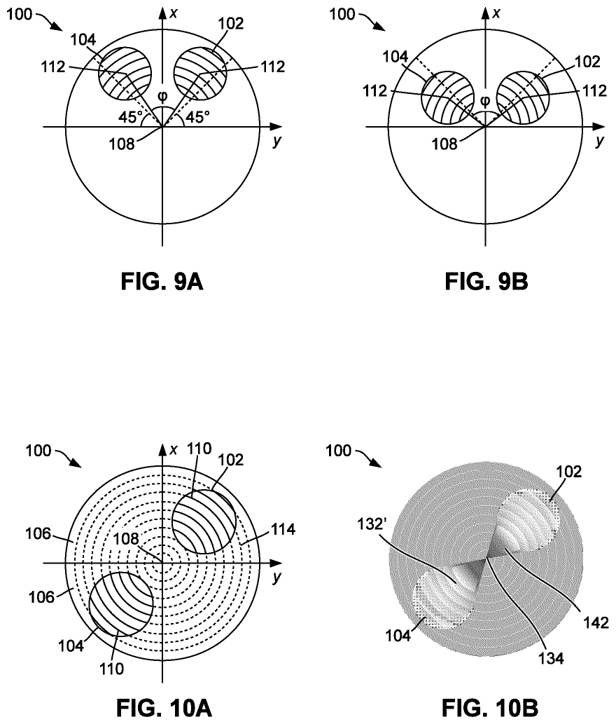

In above embodiments, the centers 112 of the illumination and collection lens portions 102 and 104 are at φ=90° with respect to the optical center 108. In some embodiments as shown in FIG. 9A, the centers 112 of the illumination and collection lens portions 102 and 104 are at an angle φ smaller than 90° with respect to the optical center 108. In some embodiments as shown in FIG. 9B, the centers 112 of the illumination and collection lens portions 102 and 104 are at an angle 9 greater than 90° with respect to the optical center 108. However, the lateral resolution in the embodiments shown in FIGS. 9A and 9B may be degraded in vertical and horizontal directions, respectively.

In above embodiments, the illumination and collection lens portions 102 and 104 are in adjacent quadrants with respect to the optical center 108, thereby allowing the illumination and collection paths to extending to the diagonally opposite quadrants, respectively, and ensuring that the illumination and collection paths do not overlap except on the focal line 134.

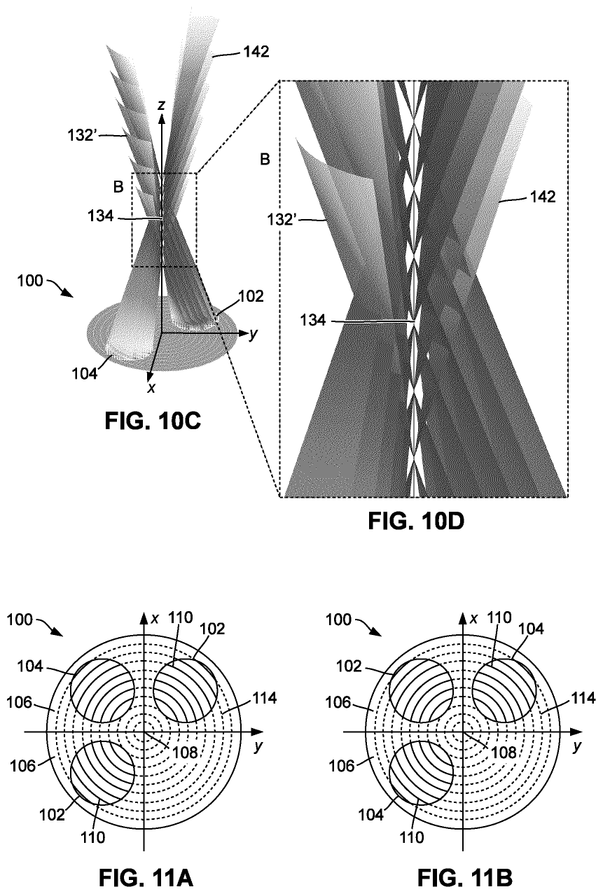

In some alternative embodiments as shown in FIGS. 10A to 10D, the illumination and collection lens portions 102 and 104 may be located in diagonally opposite quadrants and symmetric with respect to the optical center 108. However, in these embodiments, the illumination and collection paths 132′ and 142 overlap outside the focal line 134, as shown in FIGS. 9C and 9D. Wave analysis shows that such overlap may cause PSF degradation due to the presence of out-of-focus signals.

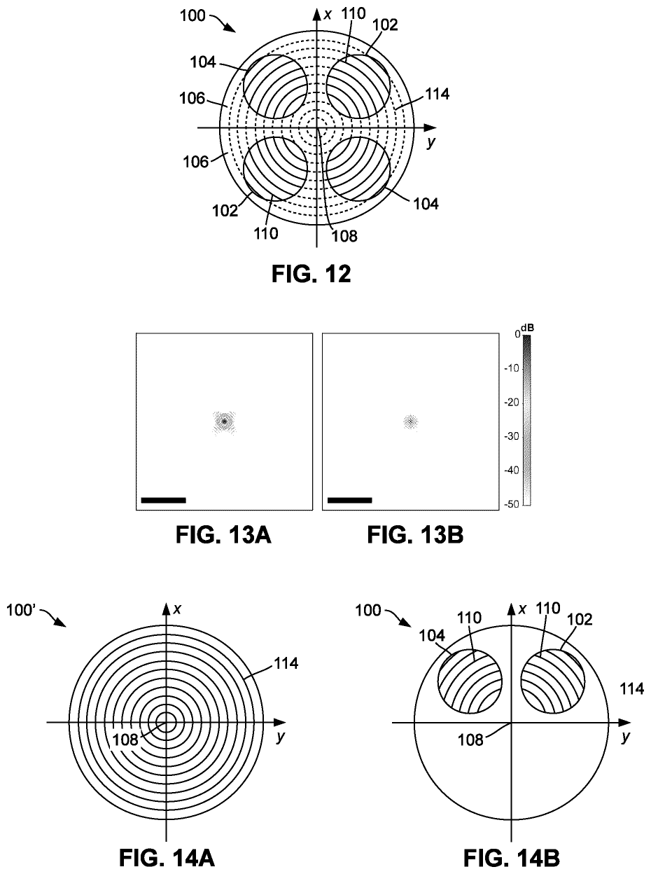

FIG. 11A shows a BICI lens 100 according to some embodiments of this disclosure. In these embodiments, the BICI lens 100 may comprise two illumination lens portions 102 located in diagonally opposite quadrants (or diagonally opposite sides of the optical center 108) and symmetric with respect to the optical center 108, and one collection portion 104 in a quadrant adjacent the two illumination lens portions 102 and symmetric with the illumination lens portions 102 about respective axes. In other words, the centers of each circumferentially neighboring pair of lens portions 102 and/or 104 are at right angle with respect to the optical center 108. While the two illumination paths in these embodiments may overlap outside the focal line 134, the collection path does not overlap with the illumination paths.

FIG. 11B shows a BICI lens 100 according to some embodiments of this disclosure. The BICI lens 100 in these embodiments is similar to that shown in FIG. 11A except that the two diagonally opposite lens portions are collection lens portions 104 and the third lens portion adjacent the two collection lens portions 104 is the illumination lens portion 102.

In some embodiments wherein the BICI lens 100 comprises three lens portions (similar to those shown in FIGS. 11A and 11B), any circumferentially neighboring pair of the three lens portions may be the illumination lens portions 102 and the other lens portion may be the collection lens portion 104.

In some embodiments wherein the BICI lens 100 comprises three lens portions (similar to those shown in FIGS. 11A and 11B), any circumferentially neighboring pair of the three lens portions may be the collection lens portions 104 and the other lens portion may be the illumination lens portion 102.

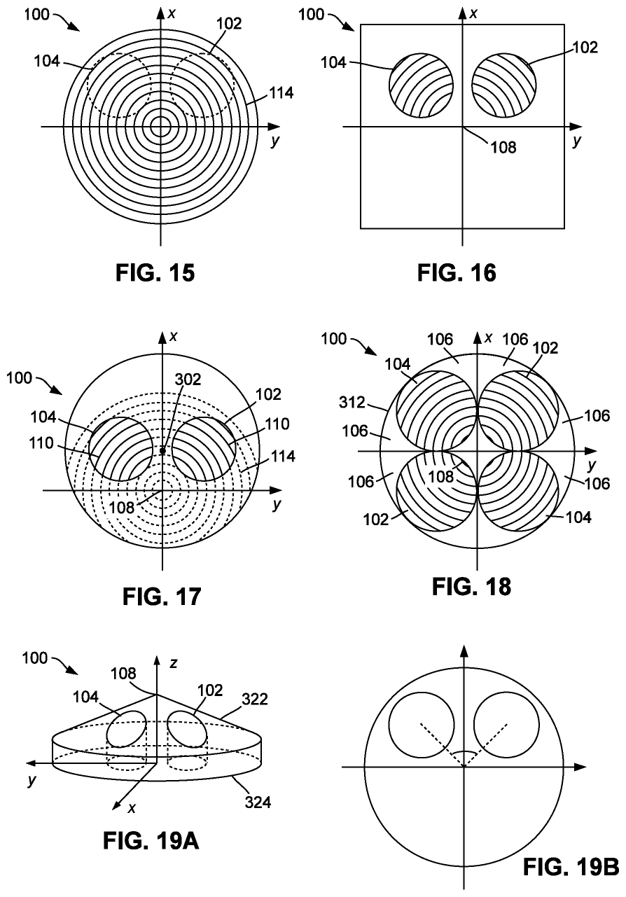

The arrangement of the illumination and collection beams in BICI necessitates using a higher bending angle (β) to achieve resolution equivalent to that obtained by imaging a focal point with an ideal diffraction-limited lens (with an NA matching the bending angle β). However, this can be rectified in some embodiments using a BICI lens 100 having two illumination and two collection lens portions 102 and 104. As shown in FIG. 12, the two illumination lens portions 102 are located in two diagonally opposite quadrants and the two collection portions 104 are located in the other two diagonally opposite quadrants. The illumination and collection lens portions 102 and 104 are symmetric about respective axes.

In these embodiments, the two illumination paths overlap outside the focal line 134, and the two collection paths also overlap outside the focal line 134. However, the collection paths do not overlap with the illumination paths.

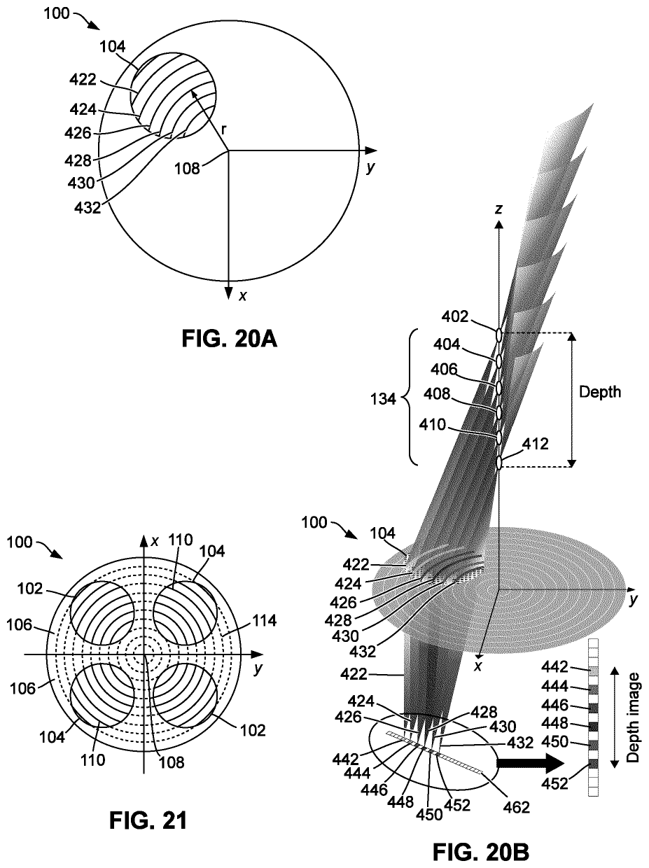

The BICI lens 100 in these embodiments maintains the required bijective relationship with improved resolution. FIGS. 13A and 13B show the comparison of the resolution of the BICI lens shown in FIG. 1A (see FIG. 13A) and that of the BICI lens shown in FIG. 12 (see FIG. 13B). Clearly, the BICI lens shown in FIG. 12 exhibits improved resolution approaching the diffraction limit (about 2 μm at NA=0.36; bending angle β=21° at 1300 nm).

In some embodiments wherein the BICI lens 100 comprises four lens portions (similar to that shown in FIG. 12), any circumferentially neighboring pair of the four lens portions may be the illumination lens portions 102 and the other two lens portions may be the collection lens portion 104.

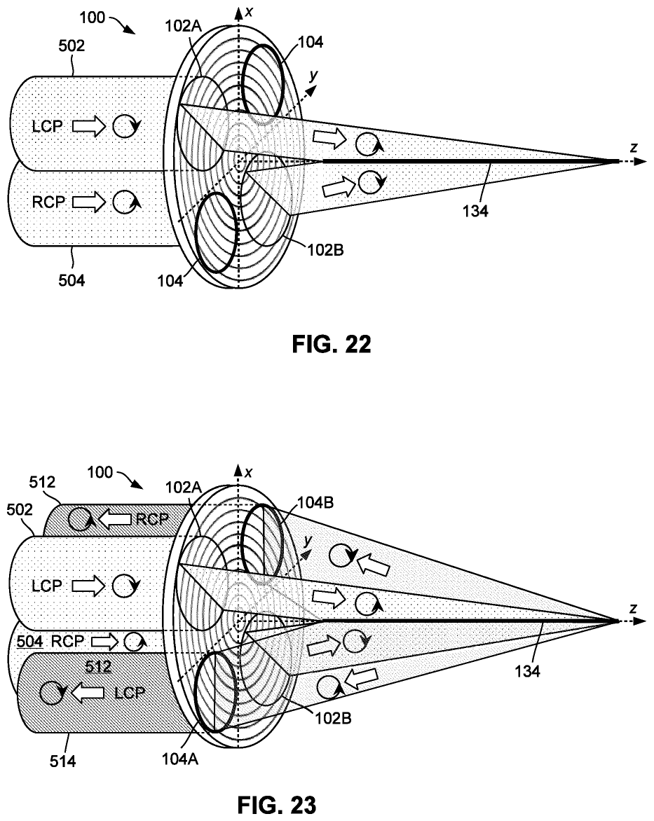

In some embodiments, the BICI lens 100 may be manufactured by fabricating a lens 100′ having a metasurface with a pattern of a plurality of concentric circles 114 centered at the optical center 108, as shown in FIG. 14A. Then, the lens 100′ is masked to opaque except the areas of the illumination and collection lens portions 102 and 104. As shown in FIG. 14B, the BICI lens 100 is then formed.

In some embodiments, the illumination and collection lens portions 102 and 104 may be first fabricated and then embedded or otherwise coupled to the BICI lens 100.

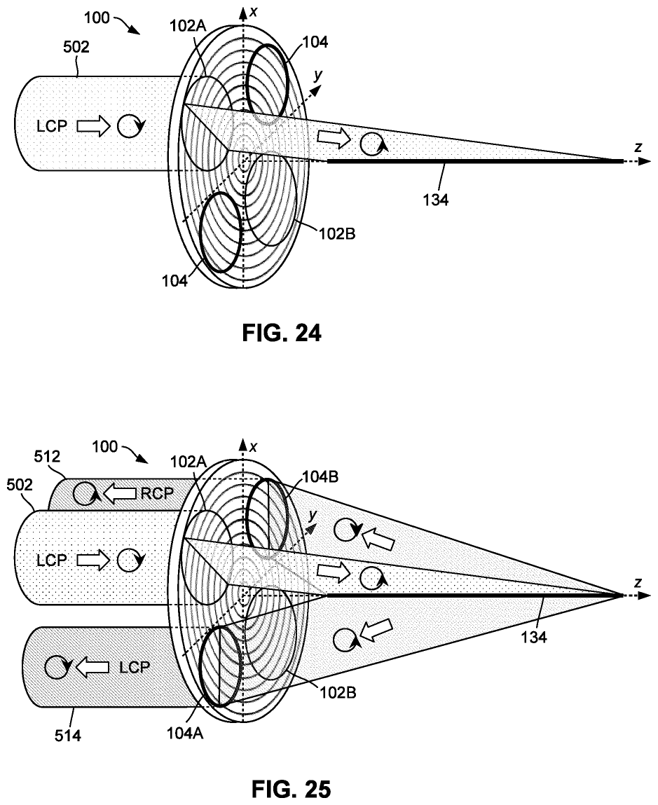

As shown in FIG. 15, in some embodiments, the BICI lens 100 may comprise a metasurface with a pattern of a plurality of concentric circles 114 centered at the optical center 108. When in use, an illumination beam (not shown) may be aimed at the area 102 to use the area 102 of the BICI lens 100 as the illumination lens portion 102, and a light collector (not shown) may be aimed at the area 104 to use the area 104 as the collection lens portion.

In some embodiments, some of the illumination and collection lens portions 102 and 104 may not be symmetric.

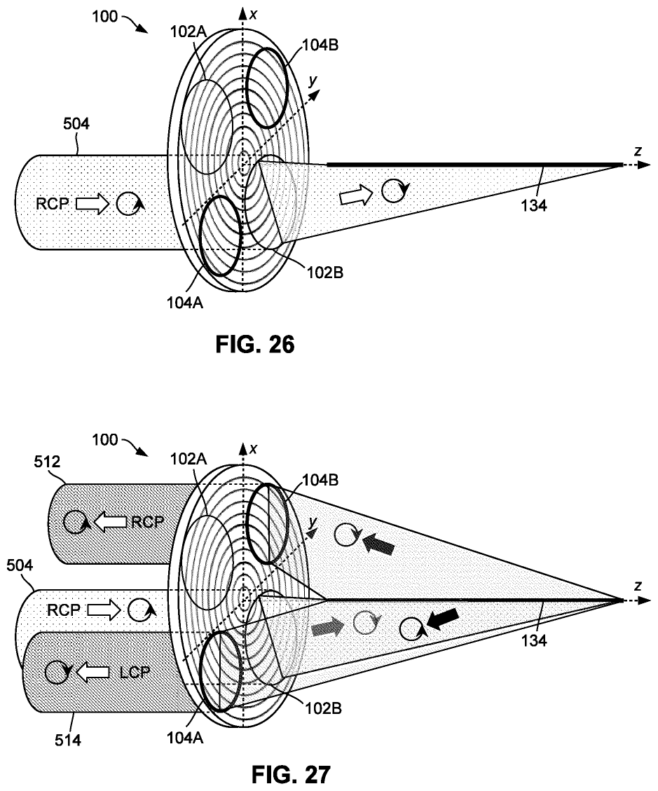

In above embodiments, the BICI lens 100 is shown as having a circular shape. In some embodiments, the BICI lens 100 may have any suitable shape such as a square shape as shown in FIG. 16.

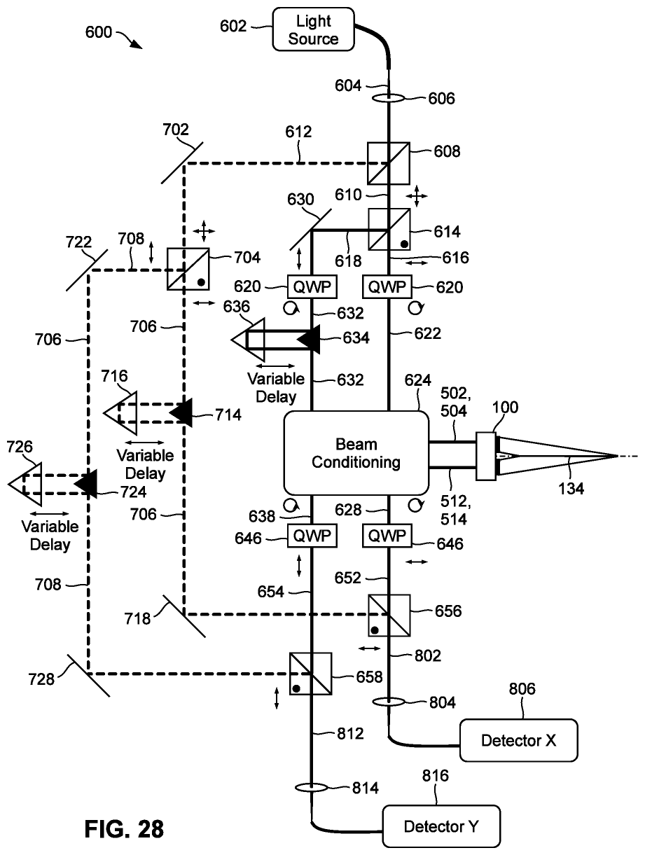

In above embodiments, the optical center 108 of the BICI lens 100 is also the centroid thereof. In some embodiments such as the embodiment shown in FIG. 17, the optical center 108 of the BICI lens 100 may be offset from the centroid 302 thereof. Each of the metasurfaces of the lens portions 102 and 104 has a pattern of arcs 110 being portions of a plurality of concentric circles 114 centered at the optical center 108.

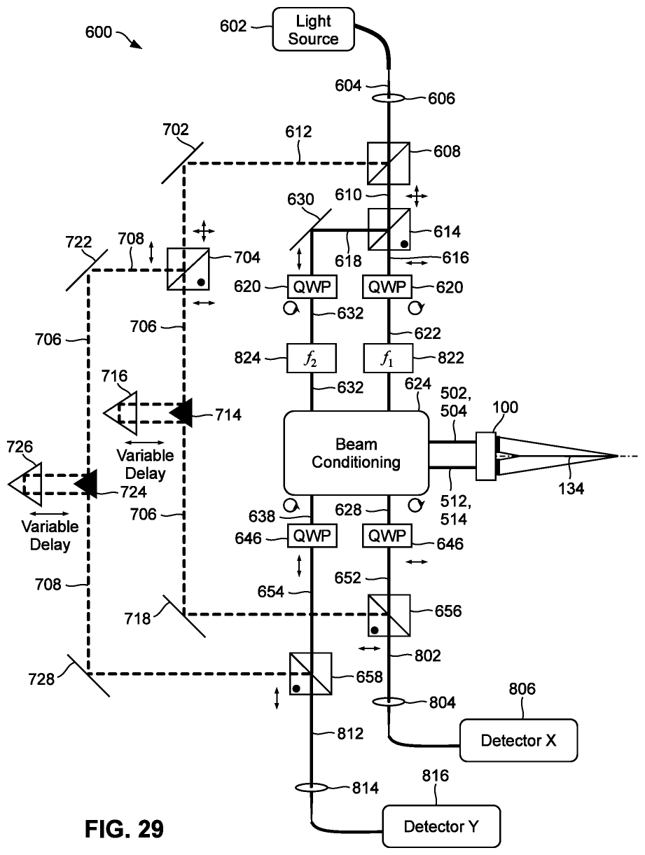

In above embodiments as shown in FIG. 18, a BICI lens 100 may comprise a plurality of illumination and collection lens portions 102 and 104 in a circular lens body 312. Each lens portion 102, 104 has a maximum size fitting in the respective quadrant and the BICI lens 100 has a plurality of unusable 106 distributed about the illumination and collection lens portions 102 and 104.

Those skilled in the art will appreciate that the illumination and/or collection lens portions 102 and 104 may be implemented using other suitable optical structures. For example, in some embodiments, the illumination and/or collection lens portions 102 and 104 and the linear phase profile in Equation (1) may be implemented using an axicon which is a lens having a conical surface.

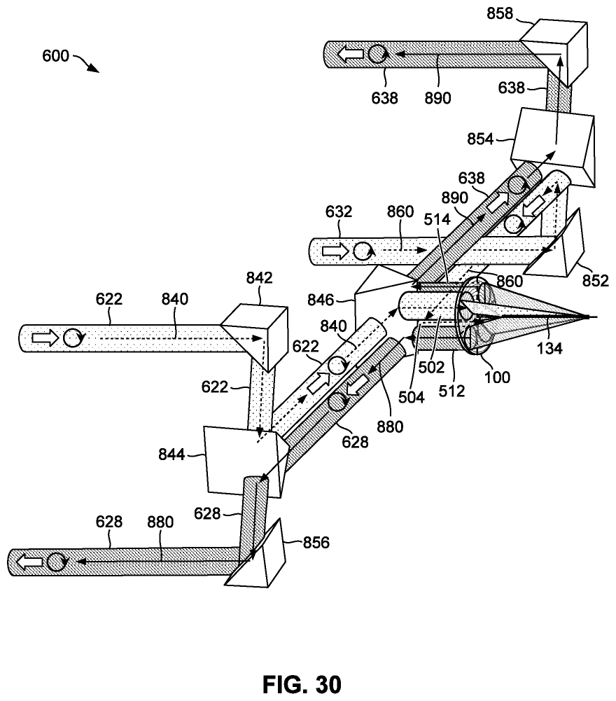

As shown in FIGS. 19A and 19B, the BICI lens 100 has a conical shape with the optical axis (that is, the z-axis) passing the vertex 108 thereof. An illumination lens portion 102 and a collection lens portion 104 are positioned at a distance away from the optical axis in neighboring quadrants of the x-y plane and symmetric about, for example, the x-axis (that is, positioned similarly to the illumination and collection lens portions 102 and 104 described above). Preferably, the center 112 of each of the illumination or collection lens portions 102 and 104 with respect to the optical center 108 is at φ=45° to the x-axis. As those skilled in the art will appreciate, similar to the description above, the illumination and collection lens portions 102 and 104 in these embodiments may be obtained by making the rest of the first surface 322 opaque, by making the rest of the send surface 324 opaque, or by aiming the illumination beam and the light collector (not shown) towards the locations of the illumination and collection lens portions 102 and 104.

The BICI lens implemented using axicon may not provide the same advantage as the BICI lens using metasurface. For example, the BICI lens using axicon may have shorter depth-of-focus than the BICI lens using metasurface for the same lateral resolution. As the resolution achieved by the BICI lens is predominantly determined by the bending angle β, given the desired resolution, one may exactly realize the required bending angle using metasurfaces. On the other hand, it may be more difficult to design a BICI lens using axicon to achieve the same bending angle β and subsequently the same resolution. Moreover, the BICI lens using axicon may be more difficult to accomplish a wide range of performances and achieve miniaturization for endoscopic applications.

In above embodiments, the BICI lens 100 comprises one or more illumination lens portions 102 and one or more collection lens portions 104 offset from the optical axis, wherein the illumination and collection lens portions 102 and 104 form a focal line 134 along the optical axis. In some embodiments, the illumination and collection lens portions 102 and 104 may be conventional lenses which, although not forming the focal line 134, have sufficient depth-of-focus (while the lateral resolution thereof may be degraded compared to the illumination and collection lens portions 102 and 104 described above). With the space-separated illumination and collection paths, the BICI lens in these embodiments may still provide superior performance than conventional lens.

In above embodiments, the BICI lens 100 comprises one or more illumination lens portions 102 and one or more collection lens portions 104 offset from the optical axis. In some embodiments, the BICI lens 100 may only comprise one or more illumination lens portion 102 offset from the optical axis. In these embodiments, light collection and imaging of the samples or target objects may be conducted using other suitable means.

In some embodiments, the BICI lens 100 may only comprise one or more collection lens portion 104 offset from the optical axis. In these embodiments, illumination of samples or target objects may be conducted using other suitable means.

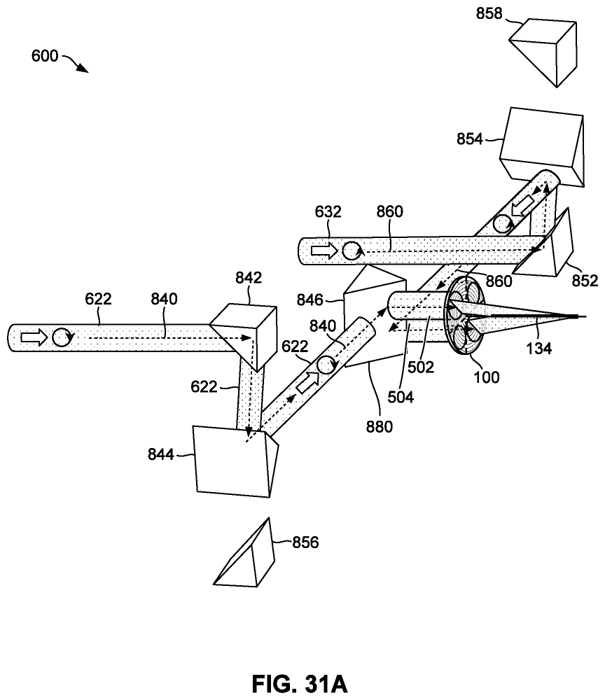

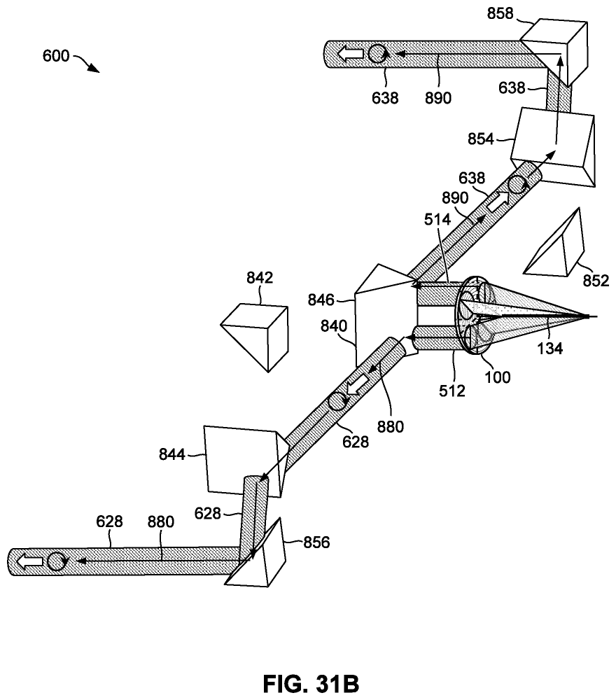

In some embodiments as shown in FIGS. 20A and 20B, the BICI lens 100 is similar to that shown in FIG. 1A except that the BICI lens 100 in these embodiments comprises a collection lens portion 104 away or offset from the optical center 108 and does not comprise any illumination lens portion.

In these embodiments, focal points such as the focal points 402 to 412 along the focal line 134 are mapped into the arcs 422 to 432 and subsequently mapped into various pixels 442 to 452 of a light detector 462 such as a camera with a line light-sensor (that is, a light sensor having a plurality of light-detection pixels arrange in a line). This is achieved when the phase of the collection lens portion 104 is engineered to map the focal line 134 onto the pixels of the light detector 462. Such a BICI lens 100 may resolve the depth information independent of OCT.

In above embodiments, the illumination and collection lens portions 102 and 104 are the usable areas for illuminating and imaging purposes and the other area of the BICI lens 100 (for example the area 106 shown in FIG. 1A) distributed about the illumination and collection lens portions 102 and 104 are unusable areas prohibited or otherwise disallowed for use (either being optically unusable (for example, being opaque) or being not allowed to use).

FIG. 2I is a schematic diagram showing a BICI lens 100 for rapid high-resolution ellipsometry (denoted a “bijective illumination collection ellipsometry (BICE)” lens hereinafter). As shown, the BICE lens 100 comprises two illumination lens portions 102 and two collection lens portions 104 on the x-y plane of the BICE lens 100 (similar to the lens 100 shown in FIG. 12). The illumination and collection lens portions 102 and 104 preferably have circular shapes of a same size.

Each of the illumination and collection lens portions 102 and 104 are positioned at a distance away from the optical axis. The two illumination lens portions 102 are located in two diagonally opposite quadrants (or the two diagonally opposite sides of the optical center 108) and symmetric with respect to the optical center 108. The two collection lens portions 104 are located in the other two diagonally opposite quadrants (or the other two diagonally opposite sides of the optical center 108) and symmetric with respect to the optical center 108. The illumination and collection lens portions 102 and 104 are symmetric about respective axes.

The illumination and collection lens portions 102 and 104 are generally the same as those described above (also see Reference 62). More specifically, the illumination and collection lens portions 102 and 104 are generally focused within a continuous focal line 134 along the optical axis (that is, the z-axis), thereby ensuring high-resolution imaging along the entire depth range. As described above, this requires all incident rays whose projections on the lens 102 or 104 have the same distance to the optical axis to be bent with the same angle towards the optical axis.

In these embodiments, the meta-surfaces of the two illumination lens portions 102 are used for illuminating the substance with light rays of two orthogonal polarization states, and the meta-surfaces of the two collection lens portions 104 are used for collecting light rays of the two orthogonal polarization states from the substance.

Each of the illumination and collection lens portions 102 and 104 comprises a metasurface for allowing light rays of a respective polarization state to pass therethrough. In the embodiments shown in FIG. 2I, the illumination lens portions 102 are designed to focus the light rays of different circular polarization states onto the focal line 134. For example, as shown in FIG. 22, the illumination lens portion 102A is designed to focus the light rays 502 of left circular polarization (LCP) onto the focal line 134, and the illumination lens portion 102B is designed to focus the light rays 504 of right circular Polarization (RCP) onto the focal line 134. In these embodiments, the metasurface of each of the illumination and collection lens portions 102 and 104 changes the polarization state of the light ray 502 or 504 passing therethrough, for example, from LCP to RCP, or from RCP to LCP.

The collection lens portions 104 are designed to collect light rays of LCP and RCP from the substance within the focal line 134, wherein the collected light rays correspond to the excitations or illuminations of the light rays incident from the illumination lens portions 102A and 102B, respectively. For example, as shown in FIG. 23, the collection lens portion 104A is designed to collect light rays 512 of LCP, and the collection lens portion 104B is designed to collect light rays 512 of RCP.

In some embodiments, the illumination light rays 502 and 504 may be separated or otherwise isolated by time-multiplexing and/or frequency-multiplexing. For example, in one example, the isolation of the illumination light rays 502 and 504 is accomplished by using interferometry when light rays 504 incident on the illumination lens 102B is time-delayed with respect to the light rays 502 incident on the illumination lens 102A. In another example, the incident light rays 502 and 504 on the illumination lens 102A and 102B are modulated at various frequencies as to be isolated from each other, and are demodulated accordingly at the receiving side.

In the example shown in FIG. 24, a single illumination lens portion (such as the LCP illumination lens portion 102A) is used for illuminating the substance within the focal line 134 using LCP light illumination 502. In these embodiments, the lens 100 may not comprise the RCP illumination lens portion 102B. FIG. 25 shows the collected light rays 512 and 514 under the LCP light illumination 502.

In the example shown in FIG. 26, a single illumination lens portion (such as the RCP illumination lens portion 102B) is used for illuminating the substance within the focal line 134 using LCP light illumination 504. In these embodiments, the lens 100 may not comprise the LCP illumination lens portion 102A. FIG. 27 shows the collected light rays 512 and 514 under the RCP light illumination 504.

In above embodiments, RCP and LCP polarization states are used. The use of RCP and LCP is suitable for ellipsometry of linear birefringent substances.

In other embodiments, other suitable two orthogonal polarization states such may be used. For example, in some embodiments, linear polarization states may be used, for example, for substances with significant optical activities (such as circular birefringence).

In the examples shown in FIGS. 22 to 27, the collected light rays 512 and 514 due to LCP and/or RCP excitations may be separated by using different time delays and/or different modulation frequencies. FIG. 28 is a schematic diagram showing an ellipsometry system 600 using the BICE lens 100 with the collected light rays 512 and 514 separated using different time delays, according to some embodiments of this disclosure.

In the ellipsometry system 600 shown in FIG. 28, a light ray 604 emitted from a light source 602 is split into two light rays 610 and 612 by a beam splitter 608, wherein each of the two light rays 610 and 612 comprises light of two orthogonal polarization states.

The light ray 610 is further split by a polarizing beam splitter 614 into two polarized light rays 616 and 618 of different polarization states. Each of the two polarized light rays 616 and 618 are passed through a respective quarter wave plate (QWP) 620 for obtaining respectively phase-shifted, polarized light rays 622 and 632, respectively. One of the phase-shifted, polarized light rays, such as the phase-shifted, polarized light ray 632, is then guided by, for example, a plurality of reflectors 634 and 636, through an additional propagation path to introducing a time delay. In these embodiments, the introduced additional propagation path may be adjustable for adjusting the introduced time delay of the the phase-shifted, polarized light ray 632.

Then, the phase-shifted, polarized light rays 622 and 632 (wherein light ray 632 is also time-delayed) are guided into a beam conditioning module 624, which outputs the illumination light rays 502 and 504 incident into the BICE lens 100 for illuminating the substance within the focal line 134 thereof. The BICE lens 100 collects light reflected and/or refracted from the substance and outputs the collected polarized light rays 512 and 514 as described above, which are guided into the beam conditioning module 624.

The beam conditioning module 624 outputs the polarized light rays 628 and 638 are passed through a respective QWP 646 for phase-shifting. The phase-shifted, polarized light rays 652 and 654 outputted from the QWPs 646 are then guided into polarized beam combiners 656 and 658, respectively.

The light ray 612 outputted from the beam splitter 608 is further split by a polarizing beam splitter 704 into two polarized light rays 706 and 708 of different polarization states. Each of the two polarized light rays 706 and 708 is guided by, for example, a plurality of reflectors 714 and 716 for polarized light ray 706, and a plurality of reflectors 724 and 726 for polarized light ray 708, through a respective additional propagation path to introducing a respective time delay. In these embodiments, the additional propagation paths of the polarized light rays 706 and 708 may be adjustable for adjusting the introduced time delays thereof. Moreover, the time delays introduced into the polarized light rays 632, 706, and 708 may be different.

The time-delayed, polarized light rays 706 and 708 are then guided into the polarized beam combiners 656 and 658, respectively.

The polarized beam combiner 656 combines the light rays 652 and 706, which have the same polarization state, and outputs a combined light ray 802 which is then guided into a light detector 806 (denoted “Detector X” in FIG. 28).

The polarized beam combiner 658 combines the light rays 654 and 708, which have the same polarization state (orthogonal to the polarization state of the light rays 652 and 706), and outputs a combined light ray 812 which is then guided into a light detector 816 (denoted “Detector Y” in FIG. 28).

FIG. 28 also shows some other optical components that may be needed (depending on the implementation), such as lens 606, 804, and 814 for respectively shaping the light rays 604, 802, and 812 as needed, and light reflectors 630, 702, 718, 722, and 728 for respectively redirecting the paths of the light rays 618, 612, 706, and 708 as needed. The ellipsometry system 600 may also comprise other optical components as needed.

FIG. 29 is a schematic diagram showing an ellipsometry system 600 using the BICE lens 100 with the collection light rays 512 and 514 separated using different frequencies, according to some embodiments of this disclosure. The ellipsometry system 600 in these embodiments is similar to that shown in FIG. 28 except that, instead of using addition propagation path for light ray 632, the ellipsometry system 600 in these embodiments comprises an optical modulator 822 for adjusting the frequency of the light ray 622 and another optical modulator 824 for adjusting the frequency of the light ray 632.

FIG. 30 is a schematic diagram showing the beam conditioning module 624 which uses knife-edge prisms and mirrors to separate the light rays, and couples the illumination and collection light rays from the BICE lens 100 to the rest of the system 600. FIG. 31A shows the path of the illumination light rays, and FIG. 31B shows the path of the collection light rays.

As indicated by the arrows 840, the polarized light ray 622 is guided to a reflector 842 such as a mirror which reflects the polarized light ray 622 to a knife-edge prism 844. The knife-edge prism 844 directs the polarized light ray 622 to a main knife-edge prism 846, which outputs the polarized light ray 622 as the illumination light ray 502 for incident to the BICE lens 100.

Similarly, as indicated by the arrows 860, the polarized light ray 632 is guided to a reflector 852 such as a mirror which reflects the polarized light ray 632 to a knife-edge prism 854. The knife-edge prism 854 directs the polarized light ray 632 to the main knife-edge prism 846, which outputs the polarized light ray 632 as the illumination light ray 504 for incident to the BICE lens 100.

As described above, the BICE lens 100 collects light rays from the focal line 134. As indicated by the arrows 880, the collection light ray 512 is guided to the main knife-edge prism 846 of the beam conditioning module 624, which directs the collection light ray 512 (renumbered as 628) to the knife-edge prism 844. The knife-edge prism 844 then directs the collection light ray 628 to the reflector 856, which outputs the collection light ray 628 from the beam conditioning module 624.

Similarly, as indicated by the arrows 890, the collection light ray 514 is guided to the main knife-edge prism 846 of the beam conditioning module 624, which directs the collection light ray 514 (renumbered as 638) to the knife-edge prism 854. The knife-edge prism 854 then directs the collection light ray 638 to the reflector 858, which outputs the collection light ray 638 from the beam conditioning module 624.

The the BICE lens 100 disclosed herein combines the principles of ellipsometry with that of the BICI lens to provide rapid high-resolution ellipsometry in a relatively large depth range.

In some embodiments, the BICE lens 100 may be readily implemented in the endoscopic setting using fiber optic components and gradient-index (GRIN) lenses to collimate the light towards the BICE lens 100 located at the distal end of an endoscope.

Although embodiments have been described above with reference to the accompanying drawings, those of skill in the art will appreciate that variations and modifications may be made without departing from the scope thereof as defined by the appended claims.

### REFERENCES

The references cited in this disclosure are listed below, the content of each of which is incorporated herein by reference in its entirety.
1. Stephens, D. J. & Allan, V. J. Light microscopy techniques for live cell imaging. Science. 300, 82-86 (2003).
2. Denk, W., Strickler, J. H. & Webb, W. W. Two-photon laser scanning fluorescence microscopy. Science. 248, 73-76 (1990).
3. Beaulieu, D. R., Davison, I. G., K₁1₁ç, K., Bifano, T. G. & Mertz, J. Simultaneous multiplane imaging with reverberation two-photon microscopy. Nat. Methods 17, 283-286 (2020).
4. Helmchen, F. & Denk, W. Deep tissue two-photon microscopy. Nat. Methods 2, 932-940 (2005).
5. Huang, D. et al. Optical coherence tomography. Science. 254, 1178-1181 (1991).
6. Fujimoto, J. G. et al. Optical biopsy and imaging using optical coherence tomography. Nat. Med. 1, 970-972 (1995).
7. Tearney, G. J. et al. In vivo endoscopic optical biopsy with optical coherence tomography. Science. 276, 2037-2039 (1997).
8. Fujimoto, J. G. Optical coherence tomography for ultrahigh resolution in vivo imaging. Nat. Biotechnol. 21, 1361-1367 (2003).
9. Vakoc, B. J., Fukumura, D., Jain, R. K. & Bouma, B. E. Cancer imaging by optical coherence tomography: Preclinical progress and clinical potential. Nat. Rev. Cancer 12, 363-368 (2012).
10. Zhou, K. C., Qian, R., Degan, S., Farsiu, S. & Izatt, J. A. Optical coherence refraction tomography. Nat. Photonics 13, 794-802 (2019).
11. Curatolo, A. et al. Quantifying the influence of Bessel beams on image quality in optical coherence tomography. Sci. Rep. 6, 23483 (2016).
12. Zhang, M., Ren, Z. & Yu, P. Improve depth of field of optical coherence tomography using finite energy Airy beam. Opt. Lett. 44, 3158-3161 (2019).
13. Yu, N. et al. Light propagation with phase discontinuities: Generalized laws of reflection and refraction. Science. 334, 333-337 (2011).
14. Lin, D., Fan, P., Hasman, E. & Brongersma, M. L. Dielectric gradient metasurface optical elements. Science. 345, 298-302 (2014).
15. Yu, N. & Capasso, F. Flat optics with designer metasurfaces. Nat. Mater. 13, 139-150 (2014).
16. Khorasaninejad, M. et al. Metalenses at visible wavelengths: Diffraction-limited focusing and subwavelength resolution imaging. Science. 352, 1190-1194 (2016).
17. Khorasaninejad, M. & Capasso, F. Metalenses: Versatile multifunctional photonic components. Science. 358, eaam8100 (2017).
18. Durnin, J., Miceli, J. J. & Eberly, J. H. Diffraction-free beams. Phys. Rev. Lett. 58, 1499-1501 (1987).
19. Berry, M. V. & Balazs, N. L. Nonspreading wave packets. Am. J. Phys. 47, 264-267 (1979).
20. Gutierrez-Vega, J. C., Iturbe-Castillo, M. D. & Chavez-Cerda, S. Alternative formulation for invariant optical fields: Mathieu beams. Opt. Lett. 25, 1493-1495 (2000).
21. Bandres, M. A., Gutierrez-Vega, J. C. & Chavez-Cerda, S. Parabolic nondiffracting optical wave fields. Opt. Lett. 29, 44-46 (2004).
22. Lopez-Mariscal, C., Bandres, M. A., Gutierrez-Vega, J. C. & Chavez-Cerda, S.

Observation of parabolic nondiffracting optical fields. Opt. Express 13, 2364-2369 (2005).
23. Fahrbach, F. O., Simon, P. & Rohrbach, A. Microscopy with self-reconstructing beams. Nat. Photonics 4, 780-785 (2010).
24. Webb, R. H. Confocal optical microscopy. Rep. Prog. Phys. 59, 427-471 (1996).
25. Stelzer, E. H. K. & Steffen, L. Fundamental reduction of the observation volume in far-field light microscopy by detection orthogonal to the illumination axis: confocal theta microscopy. Opt. Commun. 111, 536-547 (1994).
26. Born, M. & Wolf, E. Principles of Optics. (Pergamon Press, 1970).
27. Blatter, C. et al. Extended focus high-speed swept source OCT with self-reconstructive illumination. Opt. Express 19, 12141-12155 (2011).
28. Lorenser, D., Christian Singe, C., Curatolo, A. & Sampson, D. D. Energy-efficient low-Fresnel-number Bessel beams and their application in optical coherence tomography. Opt. Lett. 39, 548-551 (2014).
29. Fattal, D., Li, J., Peng, Z., Fiorentino, M. & Beausoleil, R. G. Flat dielectric grating reflectors with focusing abilities. Nat. Photonics 4, 466-470 (2010).
30. Khorasaninejad, M. & Crozier, K. B. Silicon nanofin grating as a miniature chirality-distinguishing beam-splitter. Nat. Commun. 5, 5386 (2014).
31. Arbabi, A., Horie, Y., Ball, A. J., Bagheri, M. & Faraon, A. Subwavelength-thick lenses with high numerical apertures and large efficiency based on high-contrast transmitarrays. Nat. Commun. 6, 7069 (2015).
32. Khorasaninejad, M. & Capasso, F. Broadband multifunctional efficient meta-gratings based on dielectric waveguide phase shifters. Nano Lett. 15, 6709-6715 (2015).
33. Khorasaninejad, M. et al. Achromatic metasurface lens at telecommunication wavelengths. Nano Lett. 15, 5358-5362 (2015).
34. Khorasaninejad, M., Chen, W. T., Oh, J. & Capasso, F. Super-dispersive off-axis meta-lenses for compact high resolution spectroscopy. Nano Lett. 16, 3732-3737 (2016).
35. Khorasaninejad, M. et al. Achromatic metalens over 60 nm bandwidth in the visible and metalens with reverse chromatic dispersion. Nano Lett. 17, 1819-1824 (2017).
36. Arbabi, E., Arbabi, A., Kamali, S. M., Horie, Y. & Faraon, A. Controlling the sign of chromatic dispersion in diffractive optics with dielectric metasurfaces. Optica 4, 625-632 (2017).
37. Chen, W. T. et al. A broadband achromatic metalens for focusing and imaging in the visible. Nat. Nanotechnol. 13, 220-226 (2018).
38. Yun, S. H., Tearney, G. J., de Boer, J. F. & Bouma, B. E. Removing the depth-degeneracy in optical frequency domain imaging with frequency shifting. Opt. Express 12, 4822-4828 (2004).
39. Yun, S. H. et al. Comprehensive volumetric optical microscopy in vivo. Nat. Med. 12, 1429-1433 (2006).
40. Huang, L., Whitehead, J., Colburn, S. & Majumdar, A. Design and analysis of extended depth of focus metalenses for achromatic computational imaging. Photonics Res. 8, 1613-1623 (2020).
41. Bayati, E. et al. Inverse Designed Metalenses with Extended Depth of Focus. ACS Photonics 7, 873-878 (2020).
42. Colburn, S. & Majumdar, A. Simultaneous Achromatic and Varifocal Imaging with Quartic Metasurfaces in the Visible. ACS Photonics 7, 120-127 (2020).
43. Colburn, S., Zhan, A. & Majumdar, A. Metasurface optics for full-color computational imaging. Sci. Adv. 4, 2114 (2018).
44. Ralston, T. S., Marks, D. L., Carney, P. S. & Boppart, S. A. Interferometric synthetic aperture microscopy. Nat. Phys. 3, 129-134 (2007).
45. Liu, L. et al. Imaging the subcellular structure of human coronary atherosclerosis using micro-optical coherence tomography. Nat. Med. 17, 1010-1014 (2011).
46. Yuan, W., Brown, R., Mitzner, W., Yarmus, L. & Li, X. Super-achromatic monolithic microprobe for ultrahigh-resolution endoscopic optical coherence tomography at 800 nm. Nat. Commun. 8, 1531 (2017).
47. Desjardins, A. E. et al. Angle-resolved Optical Coherence Tomography with sequential angular selectivity for speckle reduction. Opt. Express 15, 6200-6209 (2007).
48. Klein, T., Raphael, A., Wolfgang, W., Tom, P. & Huber, R. Joint aperture detection for speckle reduction and increased collection efficiency in ophthalmic MHz OCT. Biomed. Opt. Express 4, 619-634 (2013).
49. Zhao, Y. et al. Dual-axis optical coherence tomography for deep tissue imaging. Opt. Lett. 42, 2302-2305 (2017).
50. Cheng, X. et al. Comparing the fundamental imaging depth limit of two-photon, three-photon, and non-degenerate two-photon microscopy. Opt. Lett. 45, 2934-2937 (2020).
51. Wang, C., Qiao, L., Mao, Z., Cheng, Y. & Xu, Z. Reduced deep-tissue image degradation in three-dimensional multiphoton microscopy with concentric two-color two-photon fluorescence excitation. J. Opt. Soc. Am. B 25, 976-982 (2008).
52. Kobat, D., Zhu, G. & Xu, C. Background reduction with two-color two-beam multiphoton excitation. Biomed. Opt. OSA Tech. Dig. (Optical Soc. Am. 2008) BMF6 (2008) doi:10.1364/biomed.2008.bmf6.
53. Liu, J. T. C. et al. Dual-axes confocal reflectance microscope for distinguishing colonic neoplasia. J. Biomed. Opt. 11, 054019 (2006).
54. Hell, S. & Stelzer, E. H. K. Properties of a 4Pi confocal fluorescence microscope. J. Opt. Soc. Am. A 9, 2159-2166 (1992).
55. Power, R. M. & Huisken, J. A guide to light-sheet fluorescence microscopy for multiscale imaging. Nat. Methods 14, 360-373 (2017).
56. Gao, P. F., Lei, G. & Huang, C. Z. Dark-Field Microscopy: Recent Advances in Accurate Analysis and Emerging Applications. Anal. Chem. 93, 4707-4726 (2021).
57. Schmitt, J. M., Xiang, S. H. & Yung, K. M. Speckle in optical coherence tomography. J. Biomed. Opt. 4, 95-105 (1999).
58. Pahlevaninezhad, H. et al. Nano-optic endoscope for high-resolution optical coherence tomography in vivo. Nat. Photonics 12, 540-547 (2018).
59. Gissibl, T., Thiele, S., Herkommer, A. & Giessen, H. Two-photon direct laser writing of ultracompact multi-lens objectives. Nat. Photonics 10, 554-560 (2016).
60. P. S. Hauge, “Survey of methods for the complete determination of a state of polarization”, Proc. SPIE 0088, Polarization Light: Instruments, Devices, Applications, (22 Oct. 1976).
61. P. S Hauge, F. H. Dill, “A rotating-compensator Fourier ellipsometer”, Opt. Commun. 14 (1975) 431.
62. M. Pahlevaninezhad, et al, “Metasurfce-based bijective illumination collection imaging provides high-resolution tomography in three dimensions”, Nat. Photon. 16, 203-211 (2022).

1.-40. (canceled)

41. A lens comprising:
an optical center and an optical axis passing through the optical center; and
one or more lens portions;
wherein the one or more lens portions comprise at least a first lens portion for refracting light rays of a predefined polarization state impinging at right angle thereto from a first side towards the optical axis on a second side at a constant bending angle thereby defining a focal line on the second side along the optical axis.

42. The lens of claim 41, wherein the at least first lens portion is positioned at a distance away from the optical center.

43. The lens of claim 41, wherein the at least first lens portion comprises the first lens portion and a second lens portion;
wherein centers of the first and second lens portions are on diagonally opposite sides of the optical center; and
wherein the first and second lens portions are configured for passing therethrough the light rays of orthogonal polarization states.

44. The lens of claim 41, wherein the one or more lens portions further comprise:
at least a third lens portion for refracting light rays impinging at the constant bending angle thereto from the focal line on the second side to the first side at a direction parallel to the optical axis.

45. The lens of claim 44, wherein the at least a third lens portion comprises the third lens portion and a fourth lens portion;
wherein centers of the third and fourth lens portions are on diagonally opposite sides of the optical center; and
wherein the third and fourth lens portions are configured for passing therethrough the light rays of orthogonal polarization states.

46. The lens of claim 45, wherein, for a two-dimensional (2D) coordinate system defined on the lens with the origin thereof at the optical center, each of the one or more lens portions is positioned in a respective quadrant of the 2D coordinate system.

47. The lens of claim 46, wherein centers of each circumferentially neighboring pair of the one or more lens portions are at right angle with respect to the optical center.

48. The lens of claim 41, wherein the bending angle is 21°.

49. The lens of claim 41, wherein each of the one or more lens portions comprises a metasurface coupled to a substrate.

50. The lens of claim 49, wherein each metasurface comprises a plurality of nano-pillars in a pattern of arcs, said arcs being portions of a plurality of concentric circles centered at the optical center.

51. The lens of claim 41 further comprising:
an axicon with the vertex thereof being the optical center;
wherein the one or more lens portions are defined on the axicon.

52. An imaging apparatus comprising:
a polarizing beam splitter for splitting a light ray into a first polarized light ray and a second polarized light ray of orthogonal polarization states;
a beam conditioning module for receiving the first and second polarized light rays and outputting the first and second polarized light rays to the lens of claim 41; and
an adjustment module for introducing time delay to and/or for adjusting frequency of at least one of the first and second polarized light rays before the first and second polarized light rays are input into the beam conditioning module.

53. A method of fabricating the lens of claim 41, the method comprising:
depositing an amorphous silicon (a-Si) layer is on the substrate using a plasma-enhanced chemical vapor deposition;
coating a layer of negative tone photoresist on the a-Si layer;
using electron beam lithography (EBL) to create an etching pattern on the layer of negative tone photoresist; and
using deep reactive ion etching to generate a-Si nano-pillars for forming the metasurfaces of the one or more lens portions.

54. A method of using the lens of claim 45, the method comprising at least one of:
aiming a first light beam to the first lens portion; and
collecting a third light beam and a fourth light beam from the third lens portion and the fourth lens portion, respectively;
wherein the first light beam has a cross-sectional size matching a size of the first lens portion.

55. A lens comprising:
an optical center and an optical axis passing through the optical center; and
a plurality of lens portions comprising a first lens portion and a second lens portion on diagonally opposite first and second quadrants of a plane perpendicular to the optical axis for refracting light rays from a first side to a second side, and a third lens portion on a third quadrant of the plane for refracting light rays from the second side to the first side;
wherein the first and second lens portions are configured for refracting light rays impinging at right angle thereto from the first side towards the optical axis on the second side at a constant bending angle thereby defining a focal line on the second side along the optical axis, and the third lens portion is configured for refracting light rays impinging from the focal line on the second side at the constant bending angle thereto to the first side parallel to the optical axis; or
wherein the third lens portion is configured for refracting light rays impinging at right angle thereto from the second side towards the optical axis on the first side at the constant bending angle thereby defining the focal line on the first side along the optical axis, and the first and second lens portions are configured for refracting light rays impinging from the focal line on the first side at the constant bending angle thereto to the second side parallel to the optical axis.

56. The lens of claim 55, wherein the plurality of lens portions are away from the optical center.

57. The lens of claim 55, wherein the plurality of lens portions further comprises:
a fourth lens portion on a fourth quadrant of the plane for refracting light rays impinging from the focal line on the second side at the constant bending angle thereto to the first side parallel to the optical axis; or for refracting light rays impinging at right angle thereto from the second side towards the optical axis on the first side at the constant bending angle thereby towards the focal line on the first side.

58. The lens of claim 55, wherein the bending angle is 21°.

59. The lens of claim 55, wherein each of the one or more lens portions comprises a metasurface coupled to a substrate.

60. The lens of claim 55, wherein the lens comprises an axicon with the vertex thereof being the optical center; and
wherein the one or more lens portions are defined on the axicon.
